(19) United States
(12) Patent Application Publication
(10) Pub. No.: US 2009/0144173 A1
(43) Pub. Date: Jun. 4, 2009

(54) Method for converting 2d image into pseudo 3d image and user-adapted total coordination method in use artificial intelligence, and service business method thereof

(76) Inventors: Yeong-Il Mo, Seoul (KR); Suk-Gyeong Lee, Seoul (KR); Woon-Suk Chang, Seoul (KR)

Correspondence Address: FILDES & OUTLAND, P.C., 20916 MACK AVENUE, SUITE 2, GROSSE POINTE WOODS, MI, 48236, US

(21) Appl. No.: 10/583,160

(22) PCT Filed: Dec. 5, 2005
(86) PCT No.: PCT/KR05/04113

§ 371 Date: Jun. 16, 2006

(30) Foreign Application Priority Data
Dec. 30, 2004 (KR) 10-2004-0116785

(51) Int. Cl. G06Q 30/00; G06N 5/02; G06F 19/00; G06K 9/36

(52) U.S. Cl. 705/27; 706/45; 700/98; 382/285

(57) ABSTRACT

The present invention provides a method of generating a pseudo-3D user-adapted avatar by using artificial intelligence based on a method of converting a 2D image to the pseudo-3D image having visual and partial functions of a 3D model, and a method of performing a coordination simulation by applying the pseudo-3D coordination image generated by applying total clothes coordination information derived from the artificial intelligence to a user-adapted avatar. The pseudo-3D user-adapted avatar is generated by receiving primary size information and deriving secondary size information from an algorithm by using the primary size information. The pseudo-3D user-adapted avatar image suitable to the user's body shape is generated from the 2D standard avatar image. The pseudo-3D coordination image is generated, from the standard 2D image by using coordination-related information, by an artificial intelligence algorithm, and in response to a corrected pseudo-3D user-adapted avatar image, the generated pseudo-3D coordination image is displayed.

### TECHNICAL FIELD

The present invention relates to a method of user-adapted, artificial intelligence-based total clothes coordination using conversion of a 2D image into a pseudo-3D image, and a service business method using the same. More particularly, the present invention relates to a method of generating the pseudo-3D image, which depicts an image having the same visual and functional qualities as those of a 3D model, from the 2D image in a virtual space, a method of generating a pseudo-3D user-adapted avatar, a method of deriving a total clothes coordination style suitable to the tastes of a user by using artificial intelligence, a method of acquiring know-how reflecting usage results, a service method for inserting an e-commerce system module, and a service method for ordering, producing and selling goods from the pseudo-3D total clothes coordination system.

One of the applicants of the present invention previously filed the following with the Korean Intellectual Property Office (KIPO): “Coordination Operation System Using a Network and the Operation Method Thereof” (Korean Patent No. 413610) and “Coordination Operation System and Coordination Suggestion Method Thereof” (Korean Patent Laid-Open Publication No. 2003-83453).

### BACKGROUND ART

Nowadays, various simulation programs provide indirect experiences in virtual spaces using computers. Particularly, as business in Internet virtual shopping malls, namely e-commerce systems, are becoming more active, development of a virtual simulation system, in which a user is able to make realistic sensory evaluations before buying goods, is needed.

In order to provide a real-time virtual simulation, systems of both a provider server and a user terminal should have high specifications.

Nowadays, 2D simulation systems are widely used, but 3D simulation systems are being developed. 2D simulation systems have advantages in viewpoint of costs and time, because 2D simulation systems do not need real-time processing and high specifications. However, 2D simulation systems also have disadvantages in viewpoint of visual quality and other functions, in comparison with 3D simulation systems.

Particularly, visual quality may be very important in a clothes coordination system.

The clothes coordination system in a virtual space is actively being researched in the fashion field, and is explained in the present application using examples of clothes and fashion.

Most of conventional virtual clothes coordination systems are dependent on 2D images. The 3D clothes coordination systems in virtual space are needed for improving customer satisfaction, by providing appropriate clothes coordination matching a body shape and tastes of the customer. The 3D clothes coordination system may be developed by constructing a database of 3D clothes model and by matching the 3D clothes model to the body shape of the customer.

Korean Patent No. 373115 discloses a method of managing an Internet fashion mall based on a coordination simulation system. Korean Patent Laid-Open Publication No. 2002-3581 discloses a method and an apparatus of serving fashion coordination information by using personal information such as tastes, biorhythm and so on. Korean Patent Laid-Open Publication No. 2002-77623 discloses a service system that provides coordination information based on weather information, and a method of managing the system.

Japanese Patent Laid-Open Publication No. 2001-344481 discloses an Internet boutique system combining an item with an image of a customer and a selling method. Japanese Patent Laid-Open Publication No. 2002-373266 discloses a fashion coordination system of selling items appropriate to information of a customer's body shape and a method using the same. Japanese Patent Laid-Open Publication No. 2003-30496 discloses a fashion coordination system of selling items according to a place and time of the customer and a method using the same. Japanese Patent Laid-Open Publication No. 2003-99510 discloses a service method for fashion coordination by receiving fashion comments from a third party.

Korean Patent No. 373115 discloses a method of managing an Internet-based e-commerce fashion mall in which items may be purchased after being shown three-dimensionally through a coordination simulation window, in which an entertainer, an ordinary person or a customer may be a model for the items selected in the fashion mall.

On the other hand, the method of the present invention comprises generating a 3D user-adapted avatar similar to a body shape of a user, by referring to standard coordination condition data; extracting and showing items corresponding to response data selected by a user; offering various alternative simulations in which a character wears the items extracted unspecifically from the response data; and suggesting a coordination selected directly by a supplier, which provides the coordination items. Therefore, the present invention and Korean Patent No. 373115 have substantial technical differences.

Korean Patent Laid-Open Publication No. 2002-3581 discloses a method of selling items by generating fashion coordination information appropriate to an Internet user by using information including personal data such as age, sex, job, body shape and so on; fashion tastes such as preferred trends in fashion, colors and the like; a biorhythm calculated using personal information, weather, fortune, and so on, by e-mailing the fashion coordination information daily or periodically, and researched items corresponding to the fashion coordination information of the Internet user.

The above conventional method comprises transmitting coordination information, sorting items accordingly and selling an item. On the other hand, the present invention discloses a method of displaying a user-adapted 3D avatar coordinated visually by presenting a 3D avatar similar to the user's body shape, by referring to the user's responses and renewing the AI database by acquiring tastes and trends of the user from self-coordination. Therefore, the present invention and Korean Patent Laid-Open Publication No. 2002-3581 have substantial technical differences.

Japanese Patent Laid-Open Publication No. 2001-344481 discloses an Internet boutique system for selling, using total clothes coordination. The user of the Internet boutique uploads their own images, combines the images with images of selected items sold from the Internet boutique, checks the combined images and buys the desired items.

However, the above conventional system provides a desired coordination to the user appropriately by receiving at least one condition from the user connected to the coordination system through an online medium. Therefore, the present invention and Japanese Patent Laid-Open Publication No. 2001-344481 have substantial technical differences.

In South Korea, 2D coordination simulation systems using mannequins, photo images and 2D images are widely used, and 3D coordination simulation systems are being developed in universities such as Myongji University, Seoul National University and the like, and research and development are also in progress in companies. However, studies with comprehensive vision and scope have not yet been performed, and companies also have not yet performed comprehensive research and development.

In the U.S., Japan and the like, digital fashion simulation systems are being developed competitively, and also in Europe, digital fashion simulation systems are being actively studied among companies.

In the U.S., the Department of Energy (DOE) has been promoting the Demand Activated Manufacturing Architecture (DAMA) Project with more than 10 laboratories under direct government control, such as the Los Alamos National Laboratory, the Brookhaven National Laboratory and so on, textile research institutions, and 150 companies such as DuPont, and Milliken & Company that established the American Textile Partnership (AMTEX) and have been promoting studies about system analysis, simulations, 3D sewing and the like since 1993.

The Japanese government has promoted development of clothes-wearing simulation systems using depiction of a character and clothes using scaling data of the human body and Virtual/Augmented Reality, through industry-academic cooperation, such as “The Vision of the Textile Industry in the 21^{st} Century in Japan” project and the like, as part of a policy for the highly developed textile industry.

In Europe, especially in the U.K., research has been mainly conducted at the University of Leeds and the University of Bradford. In Sweden, the government has promoted the STRAP Project centering around the Swedish Institute for Fiber and Polymer (IFP) Research. Research has also been actively conducted at the University of Minho of Portugal, the Council for Scientific and Industrial Research (CSIR) of South Africa, the Commonwealth Scientific and Industrial Research Organisation (CSIRO) of Australia, the Wool Research Organisation of New Zealand (WRONZ) and the like.

Foreign companies, particularly CAD/CAM enterprises (Lectra, Gerber, Asahi, Optitex, Toyobo, Browzwear and the like) have taken interest in fashion simulation systems and are developing nearly on a commercial scale.

In schools and laboratories, MIRALab of Switzerland, the Dresden University of Technology of Germany and the like have written several papers about developing the simulations and the like but nothing on a commercial scale, and parts of papers have focused on drape simulation systems. Despite overseas interest and research, commercialized fashion simulation technology has not yet been presented.

A company having a website www.k123.co.kr provides a fashion coordination system that adjusts the size of a clothes image from another website to the size of an avatar of the website. A method to create an individual's character includes using a facial image of the avatar or substituting a facial image of the customer with the face image of the avatar. The system creates a character using the facial image of the customer and coordinates the character by fetching a desired clothes image from another website. However, because the avatar using the facial image of the customer does not reflect a body shape of the customer, the avatar is not appropriate for representing an individual's body shape. It is also difficult to revise a wide variety of clothes images from another website with correct sizes, colors and patterns.

A company having a website www.lavata.net provides a solution for a user to buy clothes after directly viewing an avatar. The company manages a system similar to the company having a website www.k123.co.kr. The system coordinates an avatar by changing a face of the avatar having a photo image like that of a mannequin to a face of the user. The system coordinates by using the face of the user, and changes the clothes by using a photo, so that the system has an effect like that of a customer directly wearing the item because there are no change in wrinkles and shapes. However, the avatar is not appropriate to a model of an individual's character because the avatar is not considered to represent the body shape of the user. The body shape of the avatar using the mannequin model cannot be changed. Also, it is impossible to change colors, patterns and sizes of the clothes using the photo image.

A company having a website www.handa.co.kr provides a coordination system that puts a clothes image on a photo model using a real model. The company provides a method of manual coordination by uploading a photo of a user and a method of coordinating a clothes image to a photo model. The system has a low effective value as a coordination system because the system requires the models be manually coordinated one by one according to a posture of the photo model, and the selection of clothes is also small. On the other hand, individual coordination by a user uploading their own photo is possible through the coordination system.

The Next Generation Apparel Related CAD and Information System (NARCIS-DS) system developed by Design & Measurement (D&M) Technology Co., Ltd. is a virtual dressing system that generates a 3D model, which can be dressed in a virtual space. The system provides easy texture mapping and changing of colors. The system creates the 3D body model by an offline module such as a 3D scanner, creates clothes using a 2D pattern CAD, and then fits the clothes to the 3D body model. The system features a fully rotatable 3D model for viewing from all sides, manual control of gaps and collisions between the clothes texture and the model, and automatic dressing of the virtual model.

The Virtual Wearing System (VWS25) system generates a pseudo-3D lattice model for a clothes image, performs pattern mapping, corrects colors and then presents various fashion styles and colors. VWS25 presents coordination in which patterns may be freely selected, and a visual quality similar to the 3D simulation. However, change of clothes size and coordination according to an individual's body shape is impossible because a photo model wears the clothes, and not a model matching an individual's body shape.

Digital Fashion, Ltd. of Japan manufactures modules for clothes to fashion shows, and provides the modules to famous websites in Japan like www.benetton.co.jp, http://rnaincjp and so on. The system generates a 3D model of a user by a 3D scanner, measures 27 parts of a body and generates an individual's character model using the measured data. The system comprises cutting and sewing 2D CAD patterns of the clothes, and fitting the clothes to the individual's character 3D model. The clothes are created for the 3D model, and pattern mapping and changing of colors are possible. The user can show the 3D model dressed naturally by physical techniques. Nevertheless, to generate an individual's own character, the model can be adjusted by region, but the resulting model after the change is unnatural. Also, the system has low visual quality because only 3D models are used, and requires a long time to load so that it is not easy to use for online purposes.

My Virtual Model, Inc., which develops 3D simulation systems in the U.S., provides a system that creates an individual's character model, puts clothes on the individual's character model by creating the clothes provided by each clothes company in 3D according to a model. The system realistically depicts the character model by mapping a skin color to a 3D model, and coordinates according to body shape by creating models by body shapes. However, the 3D shapes of the clothes have differences from real clothes in designs, colors and the like, and the resulting dressed model seems unnatural.

Optitex, Inc., which develops 2D/3D CAD/CAM solutions in New York City, U.S.A., focuses in creating and mapping textiles. The system of the company maps various textiles according to clothes and corrects colors. The company developed the Runway Designer module, which is a fitting system using a 3D model in a virtual space. The module cause shapes and colors of patterns to seem natural, but the resulting dressed 3D model seems unnatural.

MIRALab, which is a laboratory at the University of Geneva in Switzerland, has developed modules for coordination simulation in a virtual space. MIRALab is administered by Professor Nadia Magnenat-Thalmann, who is an expert of coordination simulation systems, and has authored a high number of research papers and developed technologies, with regard to physical and geometrical methods relating to 3D simulations and modeling virtual humans. The laboratory developed the coordination simulation module, which creates an individual's character by changing an entire human body model to that of an individual, and puts the clothes on the individual's character by a physical method. The module features high visual quality through textile mapping, color correction and so on, because the human body model and the clothes are developed in 3D. However, it takes a long time from creating the clothes to putting the clothes on the individual's character, and currently, only simple fashion styles can be put on the individual's character.

The conventional coordination service systems have low image quality when sizes are corrected, and as a result, all images must be made in advance and thus, have a limitation with respect to image depictions. The limitation is that only a limited combination of images can be made in advance. However, the ability to correct patterns and colors of images sizes are corrected can result in an infinite number of fashion coordination combinations. Therefore, the clothes images should be created in 3D in order to freely create fashion coordination combinations. Because corrections of sizes, patterns and colors in a 3D simulation system are possible, only a few standard images and patterns are needed; thus, an infinite number of resulting images may be created.

However, in case of generating images in 3D, the costs of producing 3D images are high and there are differences in loading speed and image quality according to a number of vertex points that are used to create a 3D model. That is, the image quality decreases but the loading speed of images increases when using a lower number of vertex points, and the image quality increases but the loading speed of images decreases when using a higher number of vertex points. Also, memory usage is high and a large amount of hard disk storage capacity is occupied when operating, because 3D simulation systems use vertex point data and surface data.

The conventional coordination simulation systems create human body models, fashion items and clothes in 3D. Due to items being depicted in 3D, most systems are configured to display items only having simple and plain shapes rather than diverse items, and are not nearly on a commercial scale. The system of the present invention is configured as a total clothes coordination simulation system unlike the conventional coordination simulation systems with respect to costs and diversity, by generating pseudo-3D images and is nearly on a commercial scale.

The conventional patents and systems using weather information, biorhythms and the like, cannot obtain optimum coordination because coordination is performed using database combinations, that is, by referring to given fashion information. Therefore, conventional coordination service systems typically do not suit the tastes of the user and are not realistic, because the system coordinates using given information from mannequins, 2D avatars, photos and the like, and do not consider the body shape of the user. Particularly, the conventional coordination service systems on websites typically show systems that simply allow the user to put the clothes on a fixed, existing avatar such as a mannequin.

Nowadays, an advanced Internet-based system is in demand, in which custom-made items, fashion, clothes and the like are developed, the orders are planned, produced, inspected and delivered after the user orders the items, and in which the user can confirm the order through a realistic simulation in real time. In most e-commerce websites some of the coordination simulation technologies are applied, but creating and selling through the simulation systems are not applied.

### DISCLOSURE OF THE INVENTION

### Technical Problem

The present invention provides a method of pseudo-3D total clothes coordination, which has fast loading times, and reduces memory usage by generating coordination images in 3D and internally processing images in 2D, providing diverse styles while providing cost and time savings for development of the coordination images.

The present invention also provides a method of generating pseudo-3D images, which may save costs and improve image quality by causing 2D images to operate like 3D images visually and functionally.

The present invention also provides a method of pseudo-3D user-adapted coordination, which coordinates styles suitable to a body shape of the user by generating the pseudo-3D user-adapted avatar suitable to the body shape of the user by using a database.

The present invention also provides a pseudo-3D total clothes coordination system, which is a total clothes coordination simulation system that uses pseudo-3D images and pseudo-3D user-adapted avatars.

The present invention also provides a method of pseudo-3D total clothes coordination using artificial intelligence, which may provide information about user-adapted coordination by learning coordination styles.

The present invention also provides a service business method of guiding a seller in selling items by providing a module to the seller who wants to use a pseudo-3D coordination program.

The present invention also provides a service business method of guiding with respect to custom-made orders, production, and selling using the pseudo-3D coordination program.

### Technical Solution

A pseudo-3D total clothes coordination method according to an example embodiment of the present invention includes preparing a 2D standard avatar image, a standard 2D image and a pseudo-3D image; entering a user's information; generating a pseudo-3D user-adapted avatar image by correcting the 2D standard avatar image automatically according to the user information; and performing an automatic coordination by converting the standard 2D image to the pseudo-3D coordination image in response to the corrected pseudo-3D user-adapted avatar image according to the user information.

According to an example embodiment of the present invention, generating the pseudo-3D image includes preparing a red-green-blue (RGB)-format 2D image; converting the 2D image to a hue-saturation-intensity (HSI)-format image; obtaining a control point of a polynomial function according to an brightness distribution chart of the HSI-formed image; producing a virtual 2D development figure by applying a physical technique to the 3D curved surface; mapping a pattern to the 3D curved surface by using the coordinate values of the virtual 2D development figure; and generating the pseudo-3D image by applying a shading function to the pattern-mapped 3D curved surface.

That is, the HSI channel value is obtained from the 2D formed image. The intensity value distribution chart is obtained from the intensity value in the HSI channel, and a maximum value and a minimum value passed by each curved surface are obtained from an equation of a multidimensional curved surface formed the distribution chart. Control points are fixed from the maximum value and the minimum value and a surface having a smooth curved surface is created by applying the B-spline equation. A 3D formed image is created by applying the shading function to a pixel value, when projecting the surface to the 2D form, and a projected angle. The present method includes obtaining the 3D formed image from the 2D image, unlike the conventional method, which includes obtaining a 3D model image by having the 3D model image created and rendered by a 3D graphic designer. Therefore, the 3D formed image having a similar quality to the conventional 3D model may be obtained at a low cost.

According to an example embodiment of the present invention, the user information includes a user's primary size information, personal information, a user's location information, a user's style information and other coordination-related information or a combination thereof.

According to an example embodiment of the present invention, generating the pseudo-3D user-adapted avatar image includes deriving a user's secondary size information automatically by using the primary size information and the personal information; and correcting the size of the 2D standard avatar image automatically using the primary size information, the secondary size information and the personal information.

According to an example embodiment of the present invention, the user information includes a facial image of the user and the facial image of the user is inserted into the generated avatar image.

According to an example embodiment of the present invention, deriving the secondary size information includes automatically performing a deriving by an artificial intelligence algorithm based on “national body size statistical data from the Korean Agency for Technology and Standards.”

According to an example embodiment of the present invention, correcting the size automatically in order to fit to a user's requirements includes dividing the 2D standard avatar image and setting control points for each of the divided groups; linearly adjusting the size of the 2D standard avatar image according to a size change by each group; and correcting a color value of each pixel according to the size adjustment.

According to an example embodiment of the present invention, correcting the color value of each pixel according to the size adjustment, performs a correction of the color value of the pixel, according to the coordinate change of the pixel through a luminance value interpolation.

For example, an individual's character is embodied as the pseudo-3D user-adapted avatar image by correcting the user size automatically by using the “national body size statistical data from the Korean Agency for Technology and Standards” and the received personal information. A relation equation is provided, which may estimate each size by parts through the personal information, such as age, and the primary size information such as a height, a weight, and a bust girth is provided from the “national body size statistical data from the Korean Agency for Technology and Standards.” The secondary size information is obtained through the relation equation. When the 2D standard avatar image is divided by parts, the point corresponding to the part is fixed to the control point and the estimated value from the relation equation is applied to the control point. The size conversion by parts is performed by using the values from before and after the change of the control point, and applying a linear conversion and the luminance value interpolation. The present invention creates the individual's character by a simple operation from the 2D standard avatar image, unlike the methods by which the conventional invention creates the individual's character by converting a body through a complicated operation according to a thickness, a height, a width and the like from the 3D model. Therefore, the pseudo-3D user-adapted avatar image is created with a lower cost and time, wherein the pseudo-3D user-adapted avatar image is the individual's character having a similar quality to the conversion from the 3D model.

A user's facial photo or a desired facial image is inserted into the generated pseudo-3D avatar so that the pseudo-3D user-adapted avatar image is created.

According to an example embodiment of the present invention, inserting a facial image to the pseudo-3D user-adapted avatar includes extracting a facial image by extracting a facial color of a facial region from the facial image and detecting a specific facial region, and adjusting a size fitting to a body shape of the pseudo-3D user-adapted avatar.

According to an example embodiment of the present invention, coordinating automatically includes: generating a most suitable pseudo-3D coordination image to the user by using the personal information, the user's location information, the user's style information and other coordination-related information or a combination thereof; embodying a result value deriving logic coordinating the pseudo-3D user-adapted avatar image using the generated pseudo-3D coordination image; acquiring modified information of the user related to the coordination result by the artificial intelligence algorithm; and reflecting the acquired modified information of the user to the result value deriving logic.

The database needs a number of tables for embodying the artificial intelligence system and the coordination result value is derived by combining the tables organically.

A “standard 2D avatar image table” includes data for skin tone, hairstyle, eye shape, face appearance, face shape and the like is prepared. A “standard body size table” received from the “national body size statistical data from the Korean Agency for Technology and Standards” is prepared.

A “standard 2D coordination item image table” including the standard clothes image information and the accessories or additional item image information, a “2D pattern image table” including pattern image information, and a “pseudo-3D image converting reference value fixing table” including reference values for converting the 2D image to the 3D image are prepared.

15 values of a “body shape and height” are derived by a sex, an age, a height, and a size from the prepared “body shape analyzing reference value table” and are referred to when outputting the coordination result values, wherein the 15 values are thin and medium, thin and very short, thin and very tall, thin and small, thin and tall, medium and medium, medium and very short, medium and very tall, medium and short, medium and tall, fat and medium, fat and very small, fat and very tall, fat and small, and fat and tall.

7 values of a “body type” are derived from the prepared “body type analyzing reference value table,” wherein the 7 values are log-shaped, log-shaped and medium, medium, triangle-shaped, inverted triangle-shaped, inverted triangle-shaped, and medium and oval.

A “table by items” is listed by items. In case of women, the table includes data for accessories, pants, blouses, coats, bags, cardigans, jackets, vests, jumpers, sweaters, caps, one-piece dresses, shoes, shirts, skirts and socks. In case of men, the table includes data for accessories, pants, coats, bags, cardigans, jackets, vests, jumpers, sweaters, caps, shoes, shirts, and socks. In this table an ID value, a color value and a pattern ID value of the standard 2D image corresponding to the condition of the item are fixed in advance.

A “personal information storage table” storing the personal information, the coordination information and the like is prepared.

A “list table of possible criteria and conditions” is prepared. In this table, local weather information from a weather station for deriving weather; criteria of other people such as a friend, a lover, a senior, a junior, a colleague and a group; criteria by purpose such as a date, a meeting, a wedding, a visit of condolence, a party, an interview, fishing and climbing; criteria by place such as a company, a house, a dance club, a restaurant, a mountain, a river, a sea, a concert, a recital, a theater, an exhibition hall and a sports stadium; and a preferred style such as a suit, a semi-suit, casual or hip-hop are fixed in advance.

A prepared “annual weather table” includes data of climate and weather like temperature, snowfall, wind speed, humidity, clouds, sunshine and the like for the previous 3 years, and 5-day and daily weather forecast information.

A “condition generating table 1” for obtaining a result value is generated by an administrator at first. A “condition generating table 2” stores data received from the coordination program user. A completed table is generated after approval of the administrator.

A “coordination result value deriving table” assembles each item and is linked with a “coordination condition-listing table.”

The present invention includes a “natural deriving result value table” and a “deriving result value ID numbers counting table” storing a user's behaviors, a “user-corrected result value table” and a “corrected result value ID numbers counting table” reflecting a user's coordination opinion and other organically combined tables.

The present invention provides an automatic coordination suitable to tastes of the user through the artificial intelligence searching system. Each group according to a fashion style, personal information, weather, a place, a job, other people and a purpose is generated from the artificial intelligence system. An organic but independent relation is built between each group, and a group code according to each group is granted to a database-formed image. The coordination simulation system automatically selects an image suitable to the tastes of the user by the code search. Knowledge acquisition is performed by the user by selecting the coordination image directly, transmitting the coordination image from the artificial intelligence system to the coordination simulation system, granting the new code value and adding the code to the database. Conventional artificial intelligence systems are largely manually controlled, because the conventional artificial intelligence systems are tree-formed structures or searching forms that search according to a user's selection. The system of the present invention is divided into an automatic part and a manual part.

In the automatic part, the coordination suitable to the tastes of the user is searched more accurately and quickly by having a property as an object independent from the fixed groups, and fixing the code from the organic relation among each group.

In the manual part, the coordination using knowledge acquisition may be accurately suitable to tastes of the user.

Therefore, the acquiring coordination simulation system may perform accurate and quick searching, unlike the conventional systems.

### EFFECT OF THE INVENTION

A service business method of the present invention includes registering standard 2D images of represented goods by classifying prepared goods and displaying recommended goods, similar to pseudo-3D item images derived from a pseudo-3D user-adapted coordination program by using artificial intelligence, because selling by preparing every derived goods as a coordination result is impossible.

A seller requests a creation of the pseudo-3D item image of a registering item to an administrator server of the system and the administrator server registers the item by creating the pseudo-3D item image, or the seller buys a pseudo-3D image creating software directly, creates the item image, requests approval of the pseudo-3D item image from the administrator of the system, and registers the pseudo-3D item image. A business or a seller who wants to use the system enters basic service member information in order to insert a code on the service homepage, is granted their own shop code through the entered information and generates an HTML tag based on the granted shop code in the service homepage. The generated HTML tag is inserted into their own website, a board and the like to sell the item, to advertise the item, to give publicity and to link items through e-mail. Therefore, a small-scale business, a SOHO business and the like, for whom it may be impossible to develop the coordination program directly, may install the coordination program of the present invention and may operate an online coordination service with their own items without high production and development costs.

When a customer finds an item similar to the item image derived by the pseudo-3D user-adapted total clothes coordination program using artificial intelligence, the customer may buy the item or a recommended item through the present invention. Also, when the customer wants to buy an item that is the same as the derived pseudo-3D item image instead of the similar item and the recommended item, a custom-made order corresponding to the derived image is requested, and the custom-made production according to the detailed body shape information of the customer is performed. A design created by the customer, a desired pattern, a pattern created by the customer and the like may be uploaded in an item generating tool and an item assembling tool, so that a custom-made item including a user name, a user photo and the like is produced.

A service business method of the present invention may evaluate a user's body shape information and a user's acquired coordination style through the pseudo-3D user-adapted coordination program using the artificial intelligence, may recommend a grade over a specific level according to the evaluated result to a fashion model candidate, and may link with scouting for models and entertainers and related management businesses.

### BRIEF DESCRIPTION OF THE DRAWINGS

The above and other advantages of the present invention will become more apparent by describing in detail example embodiments thereof with reference to the accompanying drawings, in which:

FIG. 1 is a conceptual view illustrating a pseudo-3D image converting module and a user-adapted total clothes coordinating method using artificial intelligence according to an example embodiment of the present invention;

FIG. 2 is a conceptual view illustrating a generation of a pseudo-3D user-adapted avatar in the artificial intelligence system in FIG. 1;

FIG. 3 is a conceptual view illustrating a module converting a 2D image to a pseudo-3D image;

FIG. 4 is a conceptual block diagram illustrating a pseudo-3D total clothes coordination method according to an example embodiment of the present invention;

FIG. 5 is a block diagram illustrating a face-inserting module;

FIG. 6 is a view illustrating a 2D standard avatar according to an example embodiment of the present invention;

FIG. 7 is a display view illustrating a 2D image item-generating tool according to an example embodiment of the present invention;

FIG. 8 is a display view illustrating a 2D image item-assembling tool according to an example embodiment of the present invention;

FIG. 9 is a display view illustrating a pseudo-3D image converting test tool according to an example embodiment of the present invention;

FIG. 10 is a view illustrating a principle of a B-spline.

FIG. 11 is a view illustrating a pseudo-3D surface after B-spline processing according to an example embodiment of the present invention;

FIGS. 12 through 14 are views illustrating a process of converting a virtual 3D curved surface model to a 2D model according to an example embodiment of the present invention;

FIG. 15 is a display view illustrating a pattern mapping test tool for the pseudo-3D image;

FIG. 16 is a display view illustrating a dressing tool according to an example embodiment of the present invention;

FIGS. 17 and 18 are views illustrating a size correction according to an example embodiment of the present invention;

FIG. 19 is a view illustrating a principle of luminance value interpolation after the size correction according to an example embodiment of the present invention;

FIG. 20 is a view illustrating filtering windows of images of Cb, Cr;

FIGS. 21 through 24 are block diagrams illustrating a system structure using artificial intelligence;

FIG. 25 is a conceptual view illustrating an online service business method using the pseudo-3D coordination according to an example embodiment of the present invention;

FIG. 26 is a display view illustrating an online service; and

FIG. 27 is a display view illustrating a service in a portal site and the like.

### BEST MODE FOR CARRYING OUT THE INVENTION

It should be understood that the example embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

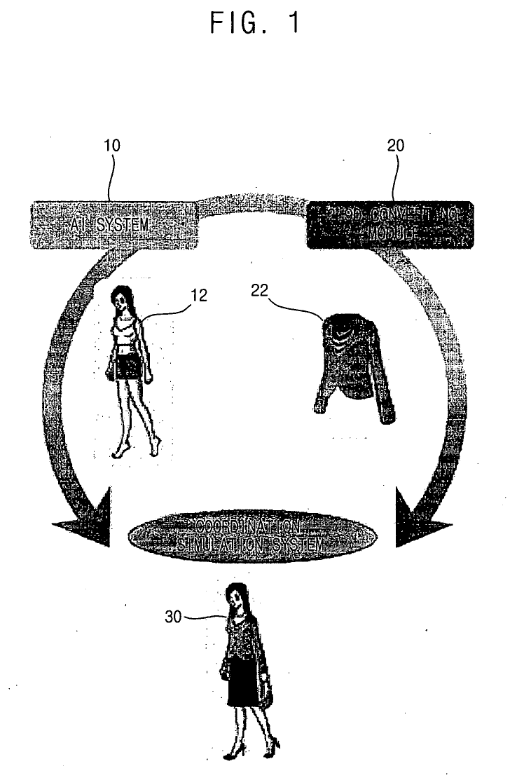

FIG. 1 is a conceptual view illustrating a pseudo-3D image converting module and a user-adapted total clothes coordinating method using artificial intelligence according to an example embodiment of the present invention. Referring to FIG. 1, the coordination system comprises an artificial intelligence (AI) system 10 that generates a pseudo-3D user-adapted avatar and an image-converting module 20 that converts a standard 2D coordination image to a pseudo-3D coordination image. The user may feel as if the user is virtually wearing the clothes, because the dressed character 30 may be matched to an appearance adapted to the user when a pseudo-3D coordination image 22 is put on a pseudo-3D user-adapted avatar 12.

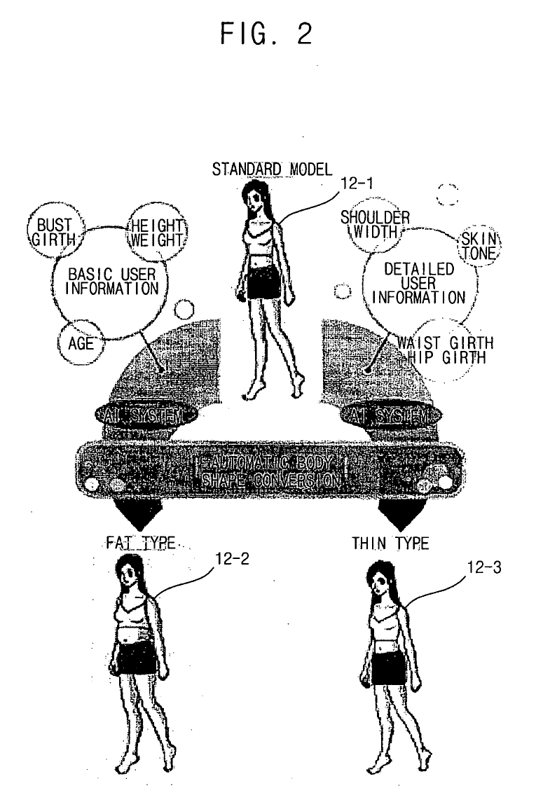

FIG. 2 is a conceptual view illustrating a generation of the pseudo-3D user-adapted avatar in the AI system 10 in FIG. 1. Referring to FIG. 2, a standard 2D avatar 12-1 is prepared based on the “national body size statistical data from the Korean Agency for Technology and Standards.” Detailed information of a user such as a shoulder width, a waist girth, a hip girth and the like, based on basic information of the user like an age, a height, a bust girth and the like, are derived by algorithms applied by the AI system. The pseudo-3D user-adapted avatar is generated by converting the standard 2D avatar 12-1 to a fat type 12-2 or a thin type 12-3 automatically, for example, a fat person to the fat type 12-2, or a thin and small person to the thin type 12-3.

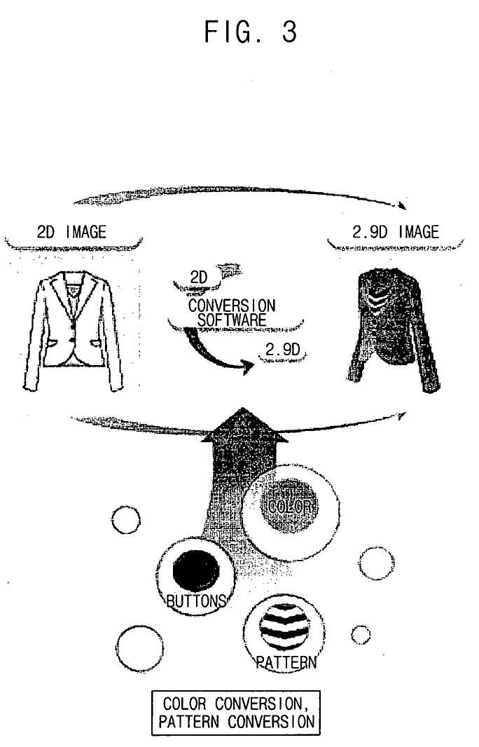

FIG. 3 is a conceptual view illustrating a module converting a 2D image to a pseudo-3D image. Referring to FIG. 3, basic clothes are designed by applying a button, a collar, a pocket, a color, a pattern and the like to the standard 2D image. A pseudo-3D image (that is, a 2.9D item image) converted from a basic item image is generated by the pseudo-3D image converting algorithms.

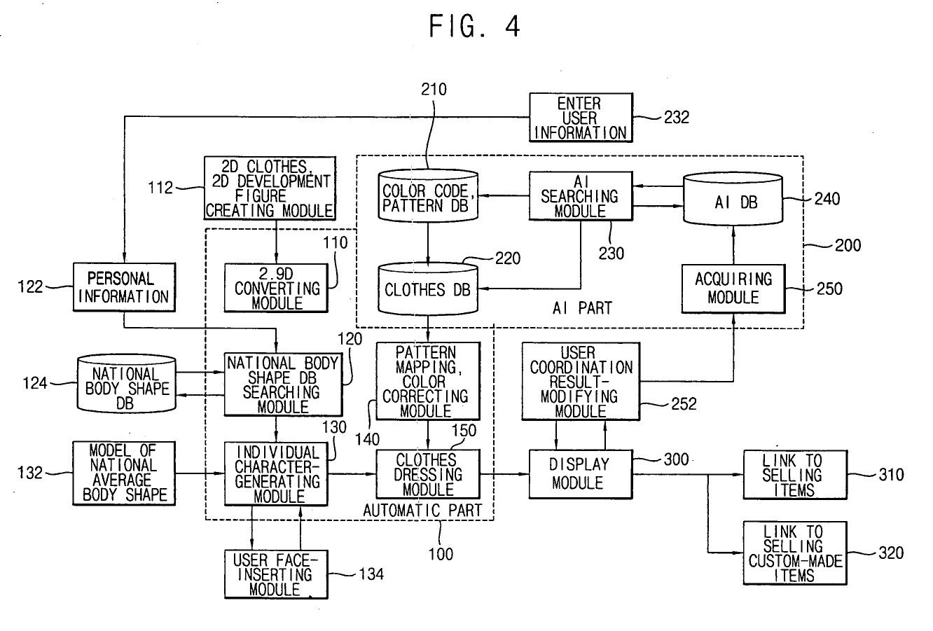

FIG. 4 is a conceptual block diagram illustrating a pseudo-3D total clothes coordination method according to an example embodiment of the present invention. Referring to FIG. 4, the coordination system comprises an automatic part 100 and an AI part 200.

The automatic part 100 comprises a 2.9D converting module 110, a national body shape database searching module 120, an individual's character generating module 130, a pattern mapping and color correcting module 140 and a dressing module 150.

The 2.9D converting module 110 converts data from a 2D clothes image, a 2D clothes development figure-creating module 112 to a 2.9D clothes coordination image.

The national body shape database searching module 120 searches, using AI, for the most similar body shape data from the prepared national body shape database 124 according to personal information 122, such as an age, a size and the like. Secondary size information is derived by estimating size by parts of body through an equation from the National Standard Body Shape Investigative Report by the National Institute of Technology and Quality, using primary size information, which is personal information such as an age, a height, a weight, a bust girth from the “national body size statistical data from the Korean Agency for Technology and Standards.”

The individual's character-generating module 130 generates the pseudo-3D user-adapted avatar by correcting the size of a model of the national average body shape 132 according to the primary size information and the secondary size information from the body shape database searching module 120.

In addition, the individual's character-generating module 130 is linked to a user face-inserting module 134. The user face-inserting module 134 replaces a facial image of the generated character model with the facial image selected by the user, for example, a desired character of the user, the user's own photo image and the like. A detailed description is as follows.

The pattern mapping and color-correcting module 140 corrects patterns and colors of the clothes coordination image produced by a 2.9D clothes coordination image database.

The dressing module 150 depicts a dressed individual's character through a display module 300 by combining the generated individual's character and the 2.9D clothes coordination image with corrected patterns and colors.

The AI part 200 comprises a color code and pattern database 210, a 2.9D clothes coordination image database 220, an AI searching module 230, an AI database 240 and an acquiring module 250.

The acquiring module 250 acquires the received user coordination inclination data from a user coordination result-modifying module 252 and stores the acquired result by renewing the data in the AI database 240. Therefore, the user coordination inclination is acquired.

The AI searching module 230 searches for the acquired user coordination style from the AI database 240 based on the personal information 232 according to the 5W1H principle. Each group is generated by applying artificial intelligence according to fashion style, personal information, weather, place, other people and purpose. Each group constructs organic but independent relations and grants a group code corresponding to each group to the database-formed coordination image. Goods suitable to tastes of user are selected automatically through a code search.

The color code and pattern database 210 generates color code and pattern data according to the searched acquired user coordination inclination data to the clothes database 220.

The clothes database 220 stores the 2.9D clothes coordination image received from the 2.9D image converting module 110 and the 2.9D clothes coordination image with applied colors and patterns according to the searched acquired user coordination inclination data to the pattern mapping and color correcting module 140.

The display module 300 links to a commercial transaction through a goods selling module 310 and a custom-made goods selling module 320 when the user wants to buy the 2.9D clothes coordination image coordinated in the depicted individual's model.

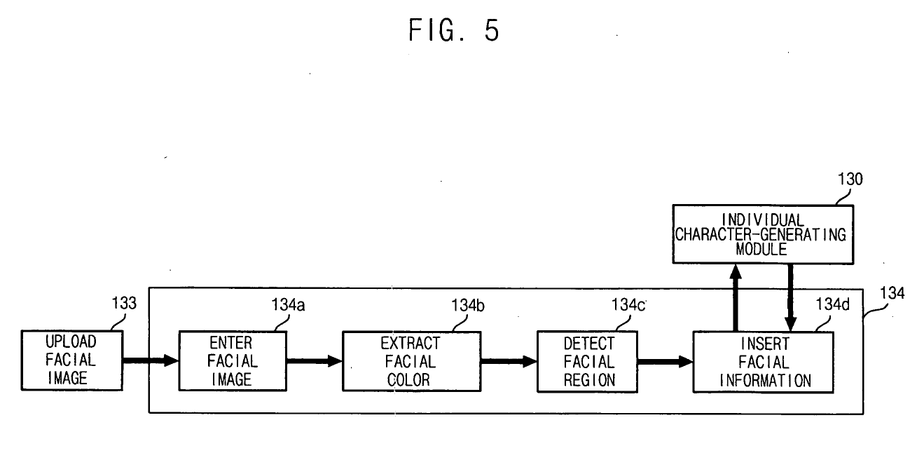

FIG. 5 is a block diagram illustrating a face-inserting module. Referring to FIG. 5, a user face-inserting module 134 composes a facial image entering part 134a, a facial color extracting part 134b, a facial region detecting part 134c and a facial information inserting part 134d.

The facial image entering part 134a receives a user photo image or a desired image from a user facial image uploading module 133 and converts the facial image except for the background and noise by filtering into a YCbCr format.

The facial color extracting part 134b extracts a facial color region after receiving the filtered YCbCr face image. Converting image into the YCbCr format is for extracting a value of the facial color. Y represents a brightness value, that is, gray image information, and Cb and Cr represent color values.

The facial image detecting module 134c detects a specific facial region from the extracted facial color region image. The facial image is divided into a Y image and Cb, Cr images and only the facial color component is extracted from each of the Cb, Cr images by using color pixel filtering. In this case, the extracted color component pixel is a skin color region value, except for a specific region of the face, and the facial region image may be derived as a gray image by applying the filtered Cb, Cr values to the Y image. The specific region value, for example, eyes, a nose, a mouth or the like, and the pixel value of the facial region are extracted by filtering the original facial image by the derived gray image.

The facial information inserting module 134d adjusts the size of the extracted facial image to the pseudo-3D user-adapted avatar, deletes the facial image information of the generated pseudo-3D user-adapted avatar, inserts the adjusted facial image information into the deleted facial image information and then the pseudo-3D user-adapted avatar may be created. The avatar is transmitted to the individual's character-generating module 130.

In a preparatory stage of the present invention, a 2D standard avatar image is created to a 2D bitmap image file. The size of the background image is 240×360. The 2D standard avatar image is created using an average age value of 18 to 24 years old referring to the “national body size statistical data from the Korean Agency for Technology and Standards.”

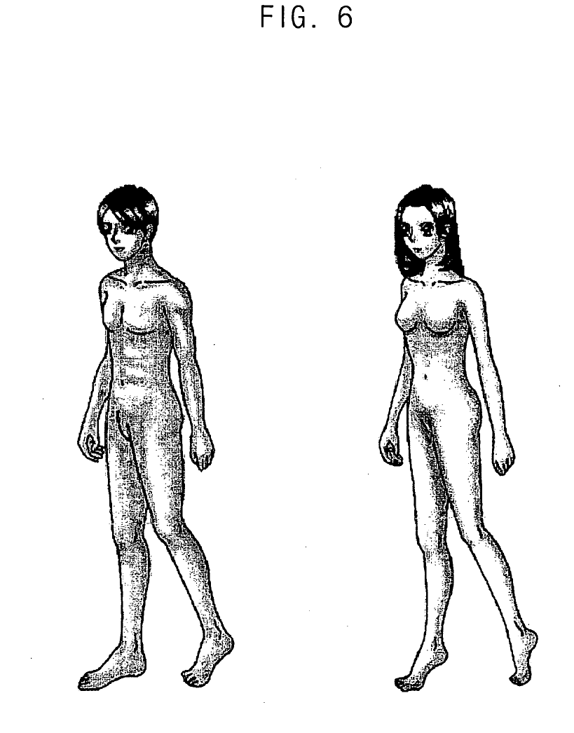

FIG. 6 is a view illustrating a 2D standard avatar according to an example embodiment of the present invention. Referring to FIG. 6, the two main types of the 2D standard avatars are male and female, respectively.

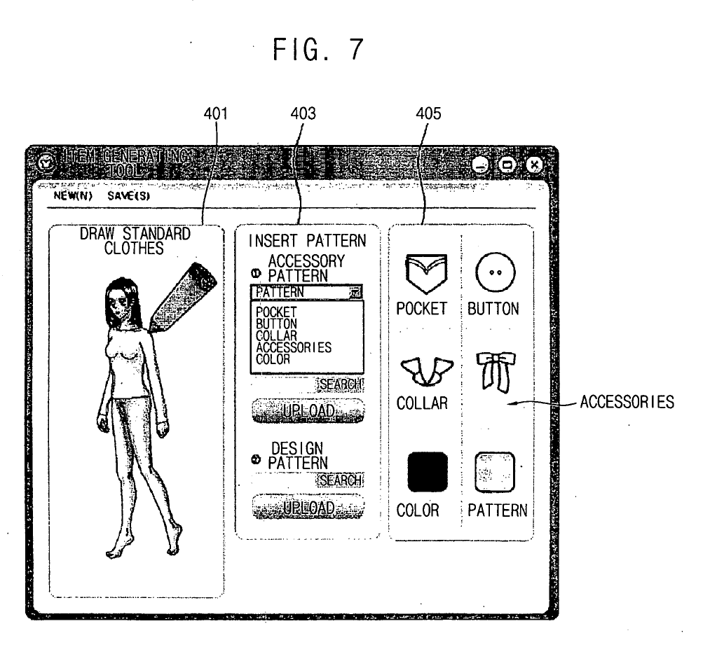

FIG. 7 is a display view illustrating a 2D image item-generating tool according to an example embodiment of the present invention. Referring to FIG. 7, items such as a button, a pocket, a color and a pattern from a figure of basic clothes are generated by the item-generating tool. A synthetic tool related to clothes is created as a basic program.

The desired design is sketched on the 2D standard avatar in a standard clothes-drawing window 401 and the clothes are generated by using patterns and accessories and the like, according to the design in a pattern inserting window 403 and an accessories window 405.

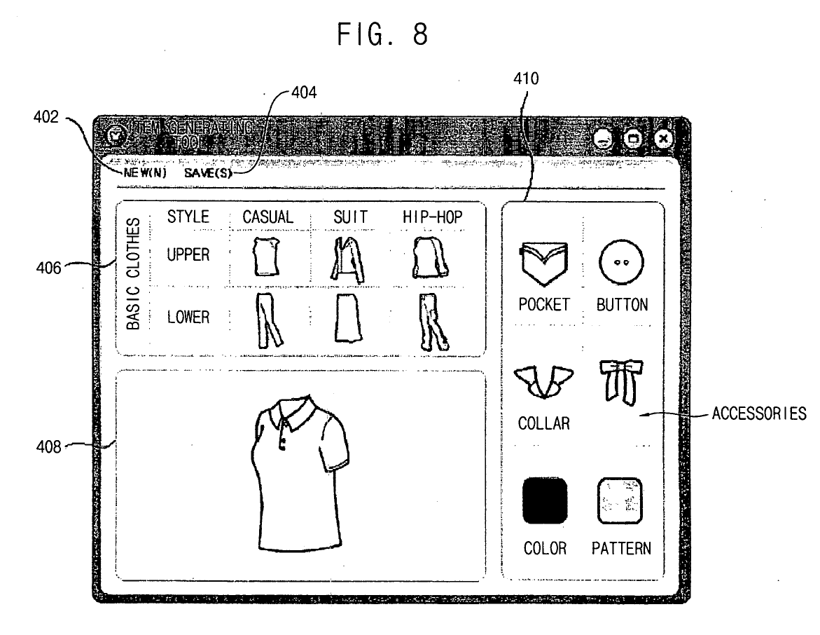

FIG. 8 is a display view illustrating a 2D image item-assembling tool according to an example embodiment of the present invention. Referring to FIG. 8, the item-assembling tool comprises NEW 402 and SAVE 404 features in the top menu. Basic clothes are selected in a basic clothes window 406, and the selected basic clothes are depicted in an operating window 408. The basic clothes of the operating window 408 are modified by selecting a button, a pocket, accessories, a collar, a color and a pattern in an appliance window 410. The 2D clothes coordination image is stored by selecting SAVE 404.

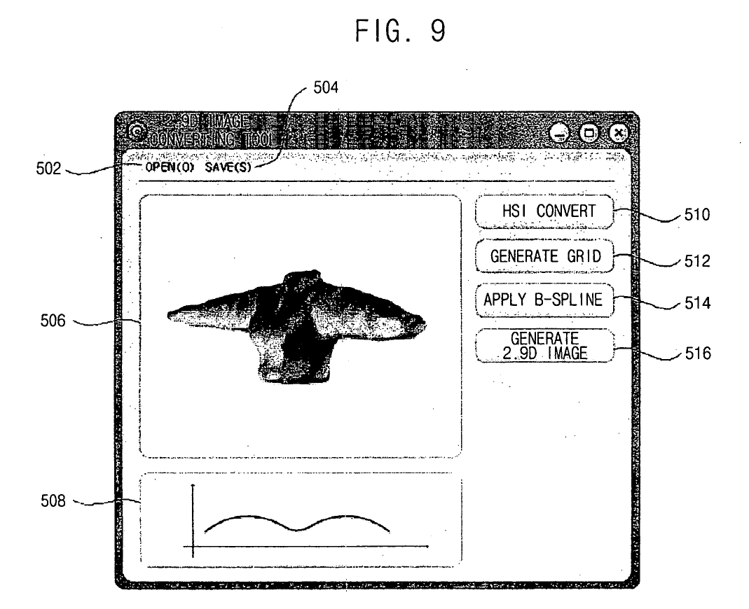

FIG. 9 is a display view illustrating a pseudo-3D image converting test tool according to an example embodiment of the present invention. Referring to FIG. 9, the 2.9D image-converting tool comprises OPEN 502 and SAVE 504 features in the top menu. The converted 2.9D coordination image is depicted in an operating window 506, and the converting tool comprises “HSI convert” 510, “generate grid” 512, “apply B-spline” 514 and “generate 2.9D image” 516 buttons.

The created 2D coordination image is opened in an operating window 506 by selecting OPEN 502 in order to convert the 2D coordination image created in the 2D coordination image-generating tool to the 2.9D coordination image. Hue-saturation-intensity (HSI) converting is performed on the 2D coordination image through the “HSI convert” 510 button.

The HSI channel is a color having a hue, a saturation and an intensity, wherein the hue is depicted as an angle range from 0 to 360 degrees, the saturation corresponds to a radius range from 0 to 1 and the intensity is corresponds to the z-axis; that is, 0 indicates black and 1 indicates white. An HSI converting value from a red-green-blue (RGB) value is as below.

$$\begin{matrix}I = \frac{1}{3} ( R + G + B ) & [ Expression 1 ] \\ S = 1 - \frac{3}{( R + G + B )} [ min ( R , G , B ) ] & [ Expression 2 ] \\ H = {cos}^{- 1} [ \frac{\frac{1}{2} [ ( R - G ) + ( R - B )}{\sqrt{{( R - G )}^{2} + ( R - B ) ( G - B )}} ] & [ Expression 3 ]\end{matrix}$$

A lattice model of the 2D clothes coordination image is generated according to the intensity through the “generate grid” 512 button. The intensity value of each 2D image pixel is depicted on the z-axis. Because the depicted 3D surface is coarse, a surface smoothing technique is applied for generating a smooth 3D curved surface. The smooth 3D curved surface is generated through the “apply B-spline” 514 button.

$$P ( u ) = {\sum }_{i = 0}^{n} {P}_{i} {N}_{i , k} ( u ) \\ {N}_{i , k} ( u ) = \frac{( u - {t}_{i} ) {N}_{i , k - 1} ( u )}{{t}_{i + k - 1} - {t}_{i}} + \frac{( {t}_{i + k} - u ) {N}_{i + 1 , k - 1} ( u )}{{t}_{i + k} - {t}_{i + 1}} \\ {N}_{i , 1} ( u ) = \{ \begin{matrix}1 & {t}_{i} \leq u < {t}_{i + !} \\ 0 & elsewhere\end{matrix} \qquad [ Expression 4 ]$$

(n+1: number of control points, k: degree)

Knot value

$${t}_{i} = \{ \begin{matrix}0 & 0 \leq i < k \\ i - k + 1 & k \leq i \leq n \\ n - k + 2 & n < i \leq n + k\end{matrix}$$

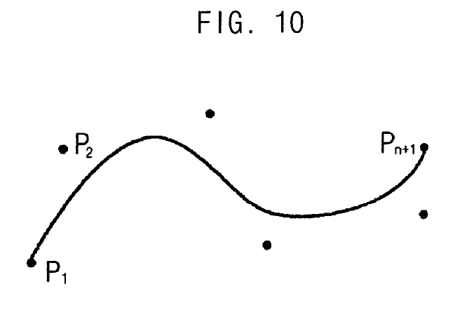

FIG. 10 is a view illustrating a principle of the B-spline. Referring to FIG. 10, each P₁, P₂, . . . , P_{N+1} indicates a set value of maximum and minimum values of the intensity value. A surface equation is represented as below by summing the above equations.

$$S ( u , v ) = {\sum }_{i = 0}^{m} {\sum }_{j = 0}^{n} {V}_{i , j} {M}_{j , q} ( v ) {N}_{i , p} ( u ) \qquad [ Expression 5 ]$$

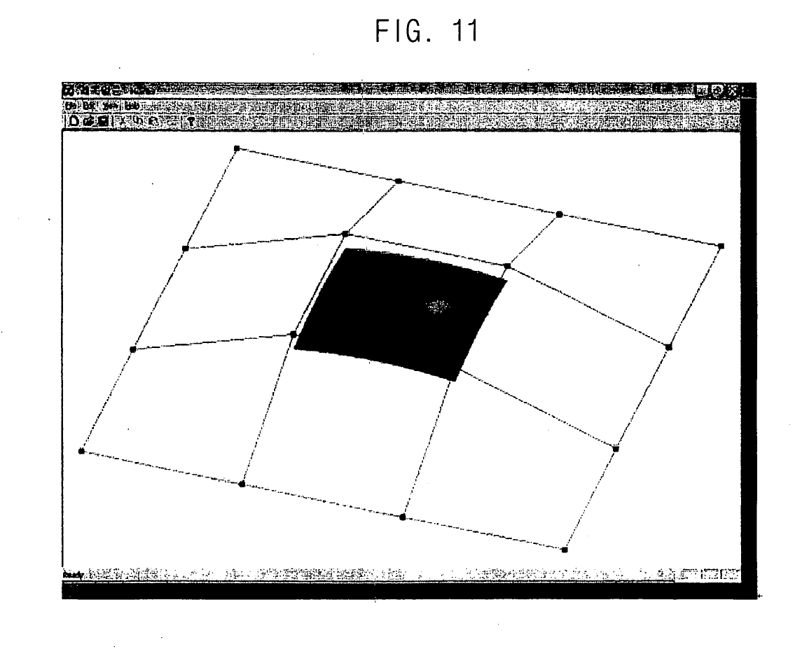

A surface formed as shown in FIG. 11 is obtained by using expression 5.

After selecting “generate 2.9D image” 516, the predetermined z-axis value and the 2D image pixel value from the B-spline are applied to a shading function to generate an image similar to the 3D model image. As the applied shading technique, a phong shading technique is used to generate the smooth curved surface. The phong shading technique is a method of depicting the surface smoothly by using a normal vector of a surface and an average value of a normal vector of a vertex point. The shading equation is as below.

ACOL=BCOL×(AMB+(1−AMB)×(VL/VNI×VNL) [Expression 6]

VCOL: color value after converting

BCOL: color value before converting

AMB: circumferential light

VL: vector of light (seeing angle and beginning point of light)

VNI: normal vector of intensity (dot product value of intensity vector)

VNL: normal vector of light (dot product value of light vector)

The 2.9D clothes coordination image is depicted similarly to the 3D clothes coordination image by an intensity processing such as that illustrated in the operating window 506 in FIG. 9. The created 2.9D clothes coordination image is stored in the clothes database 220 by selecting SAVE 504.

The color is corrected by changing the value of H in expression 3 of the HSI conversion.

In the present invention, the clothes 2D mapping sources are created according to the clothes 2.9D image in order to correct the pattern.

The clothes 2D development figure is created in the 2.9D image-converting module by using a surface generated from the B-spline according to parts of clothes. The mapping source is generated by putting the 2D model changed from the 3D curved surface on patterns. The conversion is feasible by using physical methods.

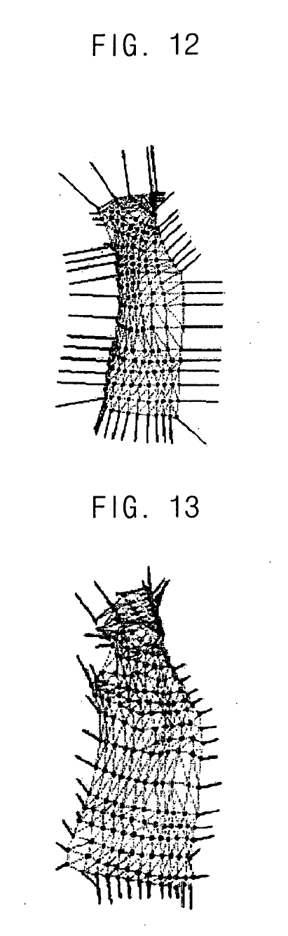

FIGS. 12 through 14 are views illustrating a process of converting a virtual 3D curved surface model to a 2D model according to an example embodiment of the present invention. Referring to FIG. 12, the vertex point of the curved surface model is a particle having mass, and the line between the vertex points is considered as a spring. A force acting on the vertex point is as below.

F=F_{g}+Fₛ+F_{d}+Fₑ [Expression 7]

wherein F_{g} is represented as below, where m denotes mass of the vertex point and g denotes the acceleration of gravity.

F_{g}=−mg [Expression 8]

wherein Fₛ is represented as below by Hooke's law, where kₛ denotes the modulus of elasticity.

$${F}_{s} = - {k}_{s} ( \vert {L}^{′} \vert - \vert L \vert ) \frac{{L}^{′}}{\vert {L}^{′} \vert} \qquad [ Expression 9 ]$$

wherein L and L′ denote edge vectors before and after changing the place of the vertex point, respectively.

$${F}_{d} = {k}_{d} ( \frac{( {V}^{′} - V ) \cdot {L}^{′}}{\vert {L}^{′} \vert} ) \frac{{L}^{′}}{\vert {L}^{′} \vert} \qquad [ Expression 10 ]$$

wherein V and V′ denote velocity vectors before and after changing the place of the vertex point, respectively. Fe denotes a force from outside. After obtaining the force acting on the vertex point, an acceleration of the vertex point is obtained by applying the equation of motion. A distance X is obtained by integrating the acceleration twice as below.

F_{g}=ma [Expression 11]

a=∂²X/∂²t [Expression 12]

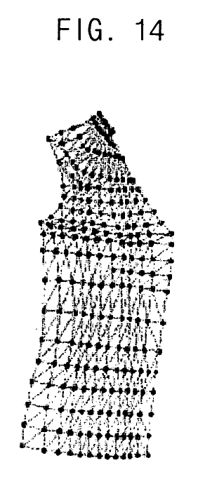

FIG. 12 is a view illustrating a boundary of the 3D curved surface, wherein the force from outside acts on the boundary. A direction of the force from outside is radical in order to smooth the 3D model. FIG. 13 is a view illustrating converting of the 3D model by acting gravity, elastic force, damping power and a force from outside compositively. FIG. 14 is a view illustrating the converted 2D model by smoothing of the 3D curved surface. The simulation is executed by applying a force from outside, calculating the force acting on each vertex point by applying expressions 7 to 10, and calculating the distance of movement of the vertex point caused by the acting force by applying expressions 11 and 12. As the process repeats, the force from outside spreads to each vertex point to then convert the 3D curved surface to the 2D model.

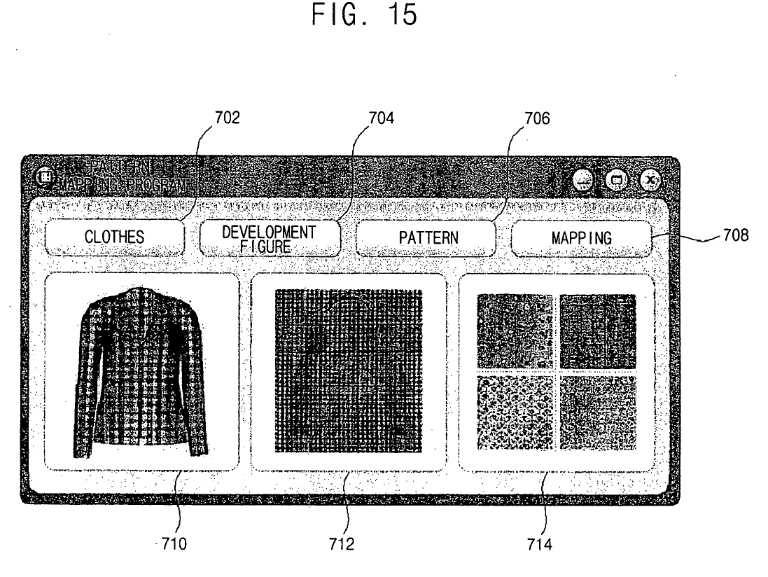

The pattern correction is performed through a pattern mapping test tool in FIG. 15. The pattern mapping test tool comprises a clothes button 702, a development figure button 704, a pattern button 706, a mapping button 708, a clothes window 710, a development figure window 712 and a pattern window 714. The 2.9D clothes coordination image is depicted in the clothes window 710 by selecting the clothes button 702. The development figure of the 2.9D clothes coordination image is depicted in the development figure window 712 by selecting the development figure button 704. The patterns are depicted in pattern window 714 by selecting the pattern button 706.

The pattern is created through scanning and outsourcing of silk fabrics.

The mapping sources are generated by putting the created 2D model on the texture mapping patterns, and the pixel value of the square in the curved surface accorded with the square forming the mapping source is mapped to the vertex point forming the curved surface and the square formed from the vertex points in the created 2.9D image.

Virtual cylindrical coordinates corresponds to the pseudo-3D model generated from the pattern. The rectangular coordinates are converted from the corresponding cylindrical coordinates by cutting and unfolding the cylinder of the cylindrical coordinates. The generated mapping source is placed on the rectangular coordinates. In this case, the distance of the cylinder is calculated according to the coordinates of the mapping source and the distance value of the pseudo 2D model, which is a cylinder to be mapped, is calculated. The calculated value is stored in a distance buffer, and the colors of the distance value of the model to be mapped and the mapping source value stored in the distance buffer are corrected by using an average filter and the pattern is mapped.

Because the color correction and the pattern mapping of the 3D model can be performed freely, the coordination simulations using the 3D model have highly researched. However, applying the service on a website and wireless services is difficult, due to the long times required to creating the 3D model, and mapping textures and rendering. A method of correcting colors and patterns in 2D is suggested to overcome these problems.

Though the mapping method used in the conventional 3D model is applied in the present invention, the 3D curved surface is generated by converting the 2D image to the 2.9D image automatically through the B-spline, and color correction and pattern mapping are performed by using the 3D curved surface; thus, costs for creating the 3D model and time for rendering are saved. Therefore, the coordination simulation may be suitable for services on websites and wireless services. Design & Measurement (D&M) Technology Co., Ltd. has a similar system which uses a 2D image and a photo. The coordination system named VWS25 generates a curved surface manually by specifying a clothes region and corrects patterns and colors manually by producing a development figure suitable to the curved surface. The problem of the system is that the whole process has be done manually before correcting patterns and colors. On the other hand, the system of the present invention requires a shorter time to map because the whole process is performed automatically.

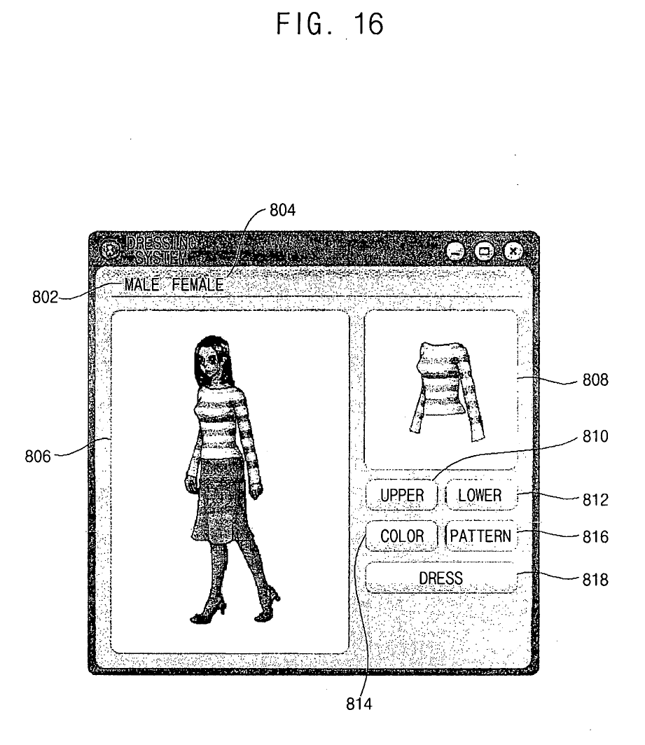

FIG. 16 is a display view illustrating a dressing tool according to an example embodiment of the present invention. Referring to FIG. 16, the dressing tool comprises a selection menu for a male 802 and a female 804, a pseudo-3D user-adapted avatar-dressing window 806, a clothes window 808, an upper clothes button 810, a lower clothes button 812, a color button 814, a pattern button 816 and a dressing button 818.

The male 802 or the female 804, which can be selected from the top menu, is displayed in the pseudo-3D user-adapted avatar-dressing window 806. Desired clothes are displayed in the clothes window 808 by selecting from the upper button 810 and the lower button 812. A color and a pattern of the displayed clothes in the clothes window 808 are corrected by correcting through the color button 814 and the pattern button 816. After determining the desired color and the pattern, the pseudo-3D user-adapted avatar in the dressing window 806 is dressed with the clothes in the clothes window 808 by clicking the dress button 818.

The 2.9D image dressing of the pseudo-3D user-adapted avatar image is performed by setting up the degrees of clearness of the pseudo-3D user-adapted avatar image and the 2.9D image, subtracting the color value of the pseudo-3D user-adapted avatar image and dressing the 2.9D image by using the degrees of clearness.

The individual's character of the present invention is generated by correcting sizes.

The relations of each body size are derived referring to the national physical standard reports.

Other sizes are derived as below from basic values like height, bust girth and age.

Shoulder width=−2.1443+0.1014×age+0.1611×height+0.1472×bust girth

Body width=−3.1576−0.0397×age+0.1183×height+0.3156×bust girth

Bust width=−2.3943+0.1948×age+0.0633×height+0.2533×bust girth

Bust thickness=1.3974+0.2088×age−0.0164×height+0.2454×bust girth

Shoulder height=−10.3699+0.1315×age+0.8565×height+0.0258×bust girth

Waist height=−7.03570−0.3802×age+0.6986×height−0.0807×bust girth [Expression 13]

Also, a control point is fixed by grouping the 2D standard avatar by parts. The fixed control point adjusts the image size fitting to the size change of each group.

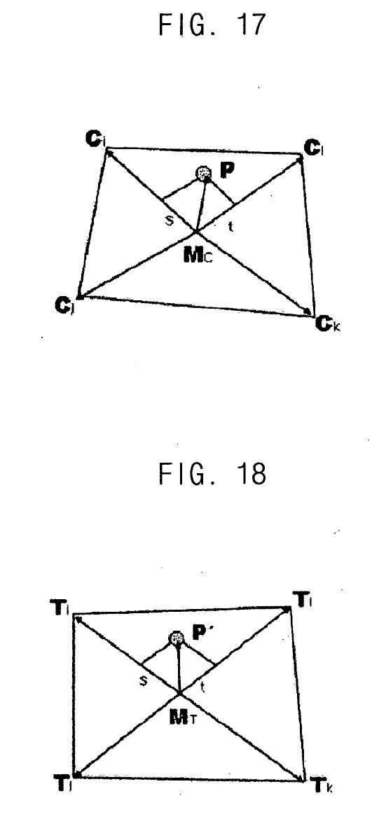

In addition, the specific region of 2D standard avatar is converted linearly with respect to the 4 control points fixed in the boundary of the converting region as shown in FIG. 17 or 18, in order to change the height and the width of the 2D standard avatar at the same time.

FIGS. 17 and 18 are views illustrating a size correction according to an example embodiment of the present invention. Referring to FIG. 17, the square CiCjCkCl represents the image region before the conversion. Referring to FIG. 18, the square TiTjTkTl represents the image region after the conversion. The points M_{C}, M_{T} represent the center of gravity of the squares CiCjCkCl and TiTjTkTl respectively. Each square is divided to 4 triangles by using the center of gravity and the image is mapped by the divided triangles linearly.

The mapping process from the pixel value P of the image before the conversion in the triangle CiMcCl in FIG. 17, to the pixel value P′ of the image after the conversion in the triangle TiM_{T}Tl in FIG. 18 is described as below. The corresponding points P and P′ are expressed as below by using the 2 sides of each triangle.

P=s(Ci−MC)+t(Cl−MC)+MC [Expression 14]

P′=s(Ti−MT)+t(Tl−MT)+MT [Expression 15]

The triangle CiMcCl is mapped to the triangle TiM_{T}Tl linearly, then s and t with respect to the corresponding points P and P′ are the same.

Ci and Ti are expressed as Ci=(cxi,cyi,czi)T, Ti=(txi,tyi,tzi)T, respectively, and s and t are calculated by using the x and y pixel coordinate values of Ci, MC, Cl and P and the x and y pixel coordinate values of P′ are calculated by applying expression 14.

Because the mapping is processed with the changes of shape, place and direction of the square according to expressions 14 and 15, the automatic conversion of the pseudo-3D user-adapted avatar image is easy. Also, the 2D standard avatar is converted naturally without discontinuity by parts and the like because the adjacent regions share the control point and the pseudo-3D user-adapted avatar image is generated with their own body sizes.

FIG. 19 is a view illustrating a principle of luminance value interpolation after the size correction according to an example embodiment of the present invention. Referring to FIG. 19, the image color of the size-corrected avatar is corrected by the luminance value interpolation. The luminance value interpolation is the method of correcting the color value of the pixel according to the change of the coordinates of the pixel. Generally, the place of the point P is not the place of a positive number pixel as shown in FIG. 18, and the luminance value of the point P is calculated from the pixel values from around the positive number location by using dual linear interpolation.

I(X,n)=(m+1−X)I(m,n)+(X−m)I(m+1,n) [Expression 16]

I(X,n+1)=(m+1−X)I(m,n+1)+(X−m)I(m+1,n+1) [Expression 17]

I(X,Y)=(n+1−Y){(m+1−X)I(m,n)+(X−m)I(m+1,n)}+(Y−n){(m+1−X)I(m,n+1)+(X−m)I(m+1,n+1))} [Expression 18]

wherein I(X,n) indicates the luminance value at the point of P=(X,Y,Z)^{T} and m,n are integers not greater than X, Y respectively.

The filtering of the facial image received in the “enter facial image” 134a step is removed by the below expression and the image in which noise is eliminated is converted to the YCbCr image.

Y=0.3×R+0.59×G+0.11×B

Cr=R−Y

Cb=B−Y [Expression 19]

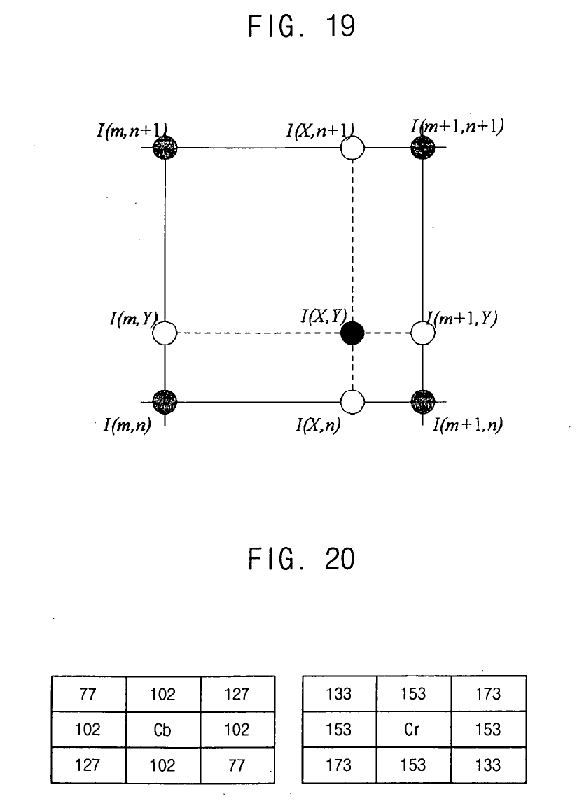

FIG. 20 is a view illustrating filtering windows of images of Cb, Cr. Referring to FIG. 20, the “extract facial region” 134b step extracts the facial region from the converted image of YCbCr through the filtering window with respect to the image of Cb, Cr.

The “detect facial image” 134c step detects the facial image and the specific facial region of the original image by filtering the gray image Y in the extracted facial region image.

The “insert facial information” 134d step inserts the detected facial region to the facial information data of the pseudo-3D user-adapted avatar and creates the pseudo-3D user-adapted avatar.

Also, the size of the clothes is adjusted to fit to the converted size of the 2D standard avatar.

The control point of the clothes corresponding to the control point of the 2D standard avatar is fixed, the size of the clothes is adjusted by the linear method fitting to the size change, according to the conversion of the 2D standard avatar, and the clothes are dressed on the avatar by gap fixing. Other clothes may be dressed on the avatar by using the relation corresponding to values between clothes and the avatar by the gap fixing.

Also, the database about the user information, the use of simulation, the purchased goods and the like is constructed by an offline customer relationship management (CRM) program and the AI acquiring is achieved by transmitting the database to the AI coordination simulation.

By using the technique, selling of the goods, the custom-made goods and the like, through e-commerce on the web and on mobile services, may be possible, and the coordination service, processing derived images to produce contents and the like may also be possible.

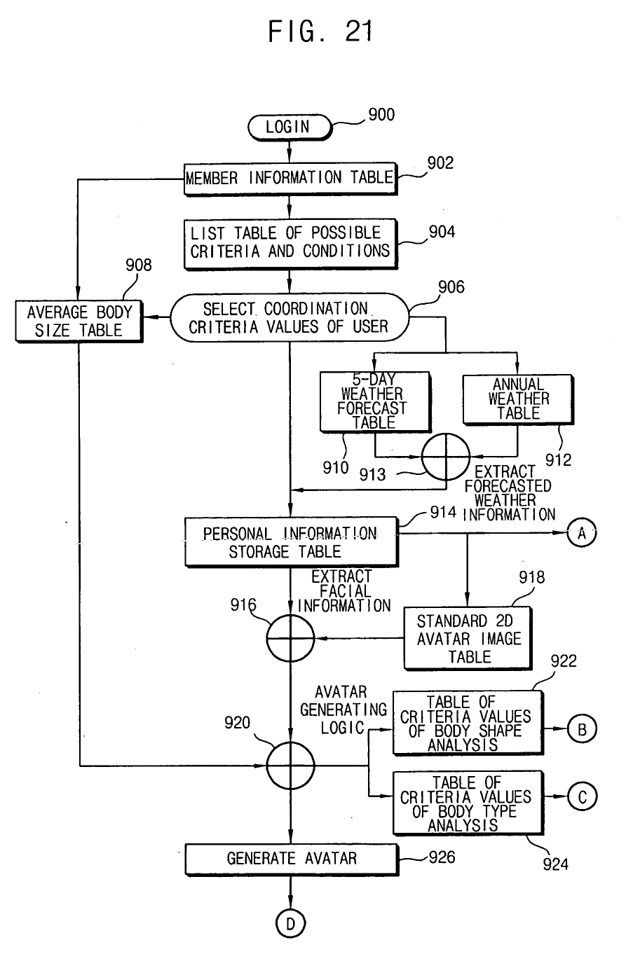

FIGS. 21 through 24 are block diagrams illustrating a system structure using artificial intelligence. Referring to FIG. 21, the user logs in 900 and the user information is recorded in a member information table 902. Also, feasible coordination criteria and condition information are recorded in a table of possible criteria and conditions 904. The coordination criteria is selected by a “select coordination criteria values of a user” 906 step referring to the “list table of possible criteria and conditions” 904. The body size information is recorded by an “average body size table” 908 according to the coordination criteria of the user received from the “select coordination criteria values of a user” 906 step.

In addition, the weather information is extracted from an “extract forecasted weather information” 913 step referring to a “5-day weather forecast table” 910 and an “annual weather table” 912 in order to apply the weather condition to the coordination criteria of the user. The user information and the selected information according to the user information are recorded in a “personal information storage table” 914.

An “extract facial information” 916 extracts the image from a “standard 2D avatar image table” 918 according to the information stored in the “personal information storage table” 914. An “avatar generating logic” 920 generates a 2D avatar 926 referring to the extracted facial information and the standard body size table.

The “avatar generating logic” 920 analyzes the body shape and the body type and lists a “table of criteria values of body shape analysis” 922 and a “table of criteria values of body type analysis” 924 according to the body type and the body shape.

That is, the “avatar generating logic” 920 refers to the information of the “member information table” 902 first, the age, the sex, the body size (the height, the weight, the bust girth) and the like in the “list table of possible criteria and conditions” 904 second and the “average body size table” 908 completes the 2D avatar in the virtual space by using expression 13, based on the standard body size detailed information (the neck girth, the shoulder width, the arm length, the underbust girth, the waist height, the hip girth, the leg length, the foot size and the like) corresponding to the user's body size.

The 2D avatar image having the facial information and the body information is loaded with respect to the sex, the age, the facial shape, the skin tone, the hair style and the like in the coordination criteria values selected in the “personal information storage table” 914. The loaded 2D avatar image and the detailed body size information are combined and the pseudo-3D user-adapted avatar is generated by using the pseudo-3D conversion method.

The body characteristic of the generated avatar is obtained by analyzing the information value calculated in the “avatar generating logic” 920, and extracting the user body shape and the user body type from the “table of criteria values of body shape analysis” 922 and the “table of criteria values of body type analysis” 924. The coordination style according to the body characteristic of the generated avatar is determined from the coordination style tables according to the body shape and the body type. Because the coordinating item is different according to the body shape and the body type, the body shape and the body type are extracted.

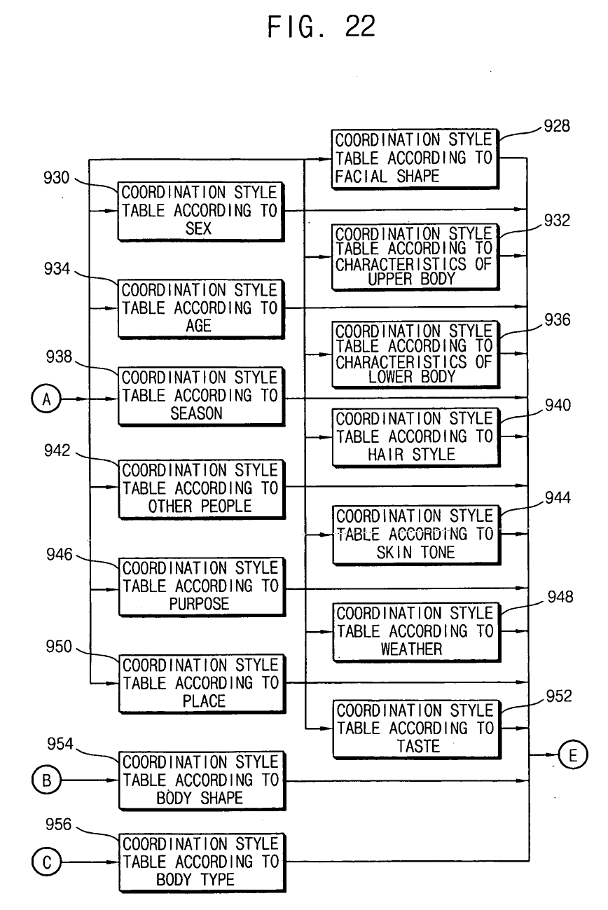

The user specific information table is generated by analyzing the information stored in the “personal information storage table” 914. Referring to FIG. 22, the coordination style tables according to a facial shape 928, a sex 930, characteristics of an upper body 932, an age 934, characteristics of a lower body 936, a season 938, a hair style 940, other people 942, a skin tone 944, a purpose 946, a weather 948, a place 950, tastes 952 and the like are listed.

Also, a “coordination style table according to body shape” 952 is listed by the criteria value of the body shape from the “table of criteria values of body shape analysis” 922, and a “coordination style table according to body type” 956 is listed by the criteria value of the body type from the “table of criteria values of body type analysis” 924.

A “coordination information extracting logic” 958 refers to each of the listed coordination style tables 928 through 956 in order to extract the coordination information.

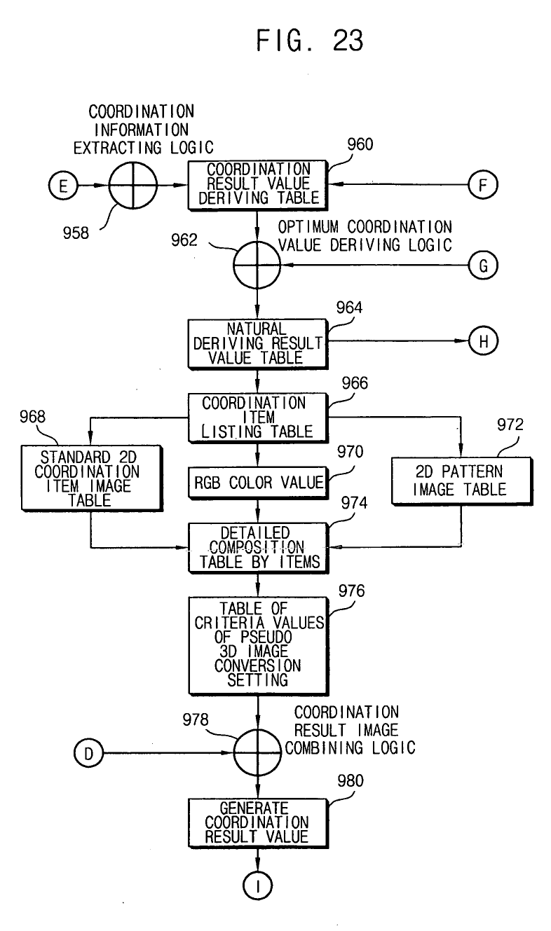

Referring to FIG. 23, a coordination information extracted from the “coordination information extracting logic” 958 is listed in a “coordination result value deriving table” 960. The coordination result value reflects the coordination acquiring result in the “coordination result value deriving table” 960.

The “coordination information extracting logic” 958 derives the coordination styles by conditions stored in the coordination style tables according to the facial shape 928, the sex 930, the characteristics of the upper body 932, the age 934, the characteristics of the lower body 936, the season 938, the hair style 940, the other people 942, the skin tone 944, the purpose 946, the weather 948, the place 950, the tastes 952 and the like based on the coordination style according to the derived body shape and the body type and the information stored in the “personal information storage table” 914 and stores the derived result value in the “coordination result value deriving table” 960. Every result value is given code values according to the order of priority and the order of priority is coded according to the organic relation of the information of each table. The order of priority is given according to the characteristic by conditions and is a subject determining the type, the age, the size, the design, the season, the color, the body shape, the sex and the like of the item. For example, in case of a miniskirt as the coordination result value, first the sex is coded to woman, and summer, teens and twenties, body having long leg, thin type and the like are coded by characteristic in turn. When the miniskirt is in fashion in winter, the code value is given to precede the code of summer and winter. The given code value is stored in the “coordination result value deriving table” 960 after searching for the code proper to the characteristic in the “coordination information extracting logic” 958, and extracting the coordination information according to the order of priority.

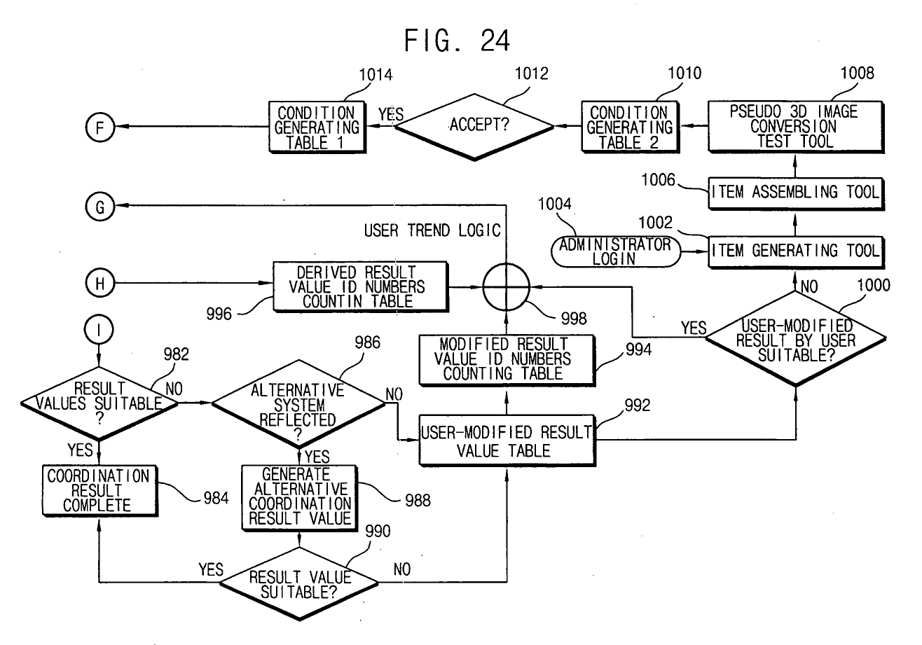

Referring to FIG. 24, an “optimum coordination value deriving logic” 962 derives the optimum coordination value referring to the “coordination result value deriving table” 960.

The “optimum coordination value deriving logic” 962 searches for the coordination result value record in the information stored in the “coordination result value deriving table” 960 according to the order of priority selecting logic and transmits the optimum coordination code value to a “natural deriving result value table” 964.

The trend code counting the results generating number according to the use of the coordination simulation by the user and the type by code according to the order of priority selected through the “coordination result value deriving table” 960 are analyzed, the optimum order of priority value is determined according to the selected coordination information and the code is generated according to the order of priority. Every result value is stored in the “coordination item listing table” 966.

The coordination item code value most similar to the generated code value is derived by using the generated code value. The derived code values are stored in the “natural deriving result value table” 964 in the order of weight of the similarity. When the generated code value is not in the conventional coordination image data, the generated code value is stored to the new data. The coordination image is generated by combining the researched item groups corresponding to the code or the additional coordination image is generated by reporting to the administrator.

The derived optimum coordination value is listed on the “natural deriving result value table” 964. The natural derived result value is offered to the “natural deriving result value table” 964 and is used to select the corresponding coordination item. The selected coordination items are offered to a “standard 2D coordination item image table” 968, an “RGB color value” 970, a “2D pattern image table” 972 and the like. The referred values in the tables 968 through 972 respectively are listed in a “detailed composition table by items” 974. The listed values of the “detailed composition table by items” 974 is offered to a “table of criteria values of pseudo-3D image conversion setting” 976.

A “coordination result image combining logic” 978 generates the coordination result value 980 by applying the criteria values of the pseudo-3D image conversion to the generated avatar from the “generate avatar” 926 step.

The “coordination result image combining logic” 978 loads the pattern item according to the coordination image from a “2D image pattern table” 972 referring to the “coordination item listing table” 966 corresponding to the “natural deriving result value table” 964, fixes color by extracting the standard 2D item from the “standard 2D coordination item image table” 968, combines the comparison values from the “detailed composition table by items” 974, generates the combined pseudo-3D image based on the comparison value and the criteria value in the “table of criteria values of pseudo-3D image conversion setting” 976 and displays the optimum coordination simulation suitable to the tastes of the user by applying the derived pseudo-3D image to the 3D user-adapted avatar. In this case, the alternative coordination simulation fetches the code value by the order of priority stored in the “natural deriving result value table” 964, combines the items and displays the coordination simulation as described above.

The generated coordination result value 980 is offered to the acquiring logic in FIG. 24.

Referring to FIG. 24, the coordination result value is checked in a “result value suitable?” 982 step, and the coordination result is completed 984 when the result value is suitable. However, when the result value is not suitable, whether the alternative system is reflected is checked 986 and the alternative coordination result value is generated 988 when reflecting the alternative system. Whether the alternative result value is suitable is checked 990 and the coordination result is completed 984 when the alternative coordination value is suitable.

When the coordination result is not suitable, the user-modified result value table 992 and the modified result value ID numbers counting table 994 are listed and the derived result value ID numbers from the natural deriving result value table 964 are listed on the derived result value ID numbers counting table 996. That is, when the user determines the coordination result value is not the style of the user, the user may load the alternative coordination system of their own accord or may process the coordination simulation proper to the tastes of the user by loading the coordination simulation manually. The alternative coordination system is the coordination simulation system alternating the nearest styles to the tastes of the user among the coordination information having the lower order of the priority without the optimum coordination value in the “coordination result value deriving table” 960. When the user determines the alternative coordination result is not proper to oneself, the user may proceed with the coordination simulation manually. In this case, the coordination result value coordinated by user manually is stored in the user-modified result value table 992, the stored value is offered to the modified result value ID numbers counting table 994 and a user trend logic 998 reflects the stored value to the optimum coordination deriving logic.

The user trend logic 998 analyzes the ID counting values and offers the analyzed user coordination inclination result value to the optimum coordination value deriving logic 962. The offered coordination inclination result value is applied in the coordination value deriving logic 962 when deriving the next coordination from the acquired user coordination inclination result. That is, the user trend logic 998 fetches the counting information value according to the coordination image data selected by the many users from the modified result value ID numbers counting table 994 and reflects the trend inclination by heightening the order of priority with respect to the trend characteristic value among the code value of the coordination image. Because the specific coordination image selected by the many users indirectly represents that the coordination image is in fashion, the order of priority of the trend inclination in the coordination image code value should be heightened. The order of priority of trend is determined according to the reflection ratio of the derived result value ID numbers counting table 996 and the modified result value ID numbers counting table 994, and the trend value is reflected to the optimum coordination deriving logic 962 in order to derive the optimum coordination result value.

A “user-modified result by user suitable?” 1000 step checks whether the user-modified result is suitable. When the user-modified result is suitable, the result is reflected to the “user trend logic” 998.

However, when the user-modified result is not suitable 1000, the user-modified result is offered to the “pseudo-3D image converting test tool” 1008 through the “item generating tool” 1002 and the “item assembling tool” 1006 in order to correct the item. The result is listed on the “condition generating table 2” 1010 and an “accept?” 1012 step determines whether the listed condition-generating tool is suitable. When the condition is suitable, a “condition generating table 1” 1014 is listed and the condition is applied to the “coordination result value deriving table” 960.

When the user determines that the coordination image manually combined by the user is not suitable or wants the custom-made order, the user may create the items by using the item generating tool 1002 and the item assembling tool 1006 and see the 3D converted item image through the pseudo-3D converting program. The generated items are reflected in the coordination simulation system after going through a sequence of steps and are generated in the new item group.

The coordination image manufactured by the user is stored in the “condition generating table 2” 1010 and the administrator determines whether the coordination image manufactured by the user is suitable in the “accept?” 1012 step. When the administrator determines that the coordination image manufactured by the user is suitable, the “condition generating table 1” 1014 reflects the coordination image manufactured by the user, the reflected coordination image is stored in the image table and the stored coordination images may be converted to the pseudo-3D images possible to be simulated.

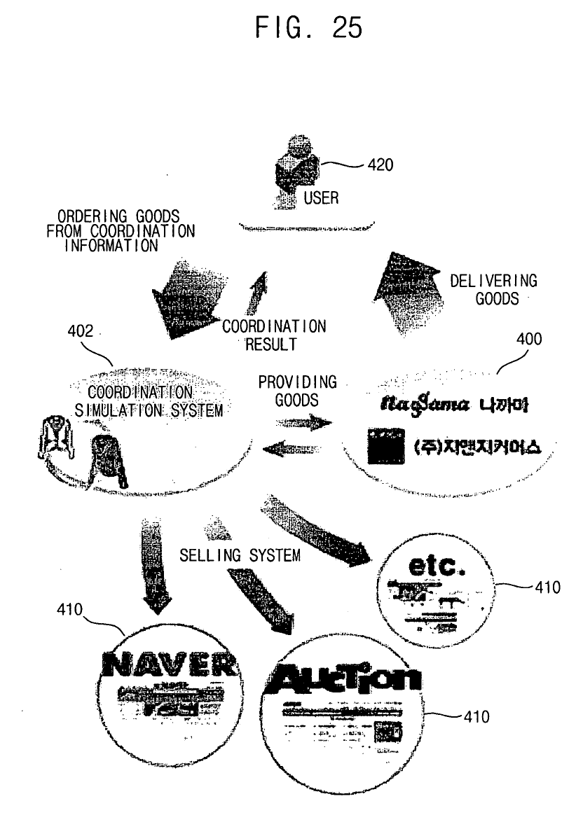

FIG. 25 is a conceptual view illustrating an online service business method using the pseudo-3D coordination according to an example embodiment of the present invention.

A portal site, an auction site, a clothes fashion site or whatever online trader 410, a small-scale business or a small office, home office (SOHO) business registers the pseudo-3D item image for selling in the online service business server 400. The registered pseudo-3D item image is registered in the database of the coordination simulation system 402.

The business 410 who wants to use the system may insert HTML tags based on the shop code granted from the managing server, according to the demand for the services on their own website or on the board and link to advertisements and the selling goods.

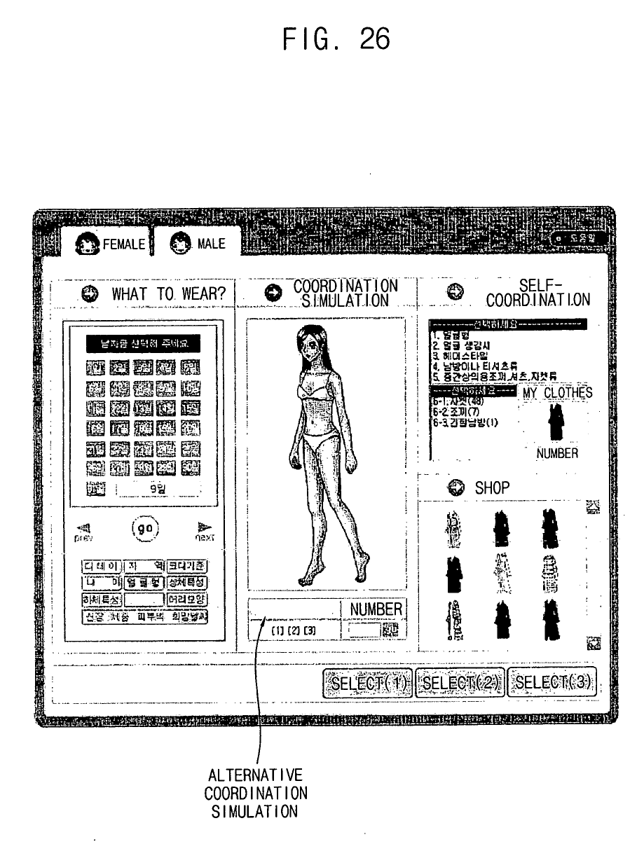

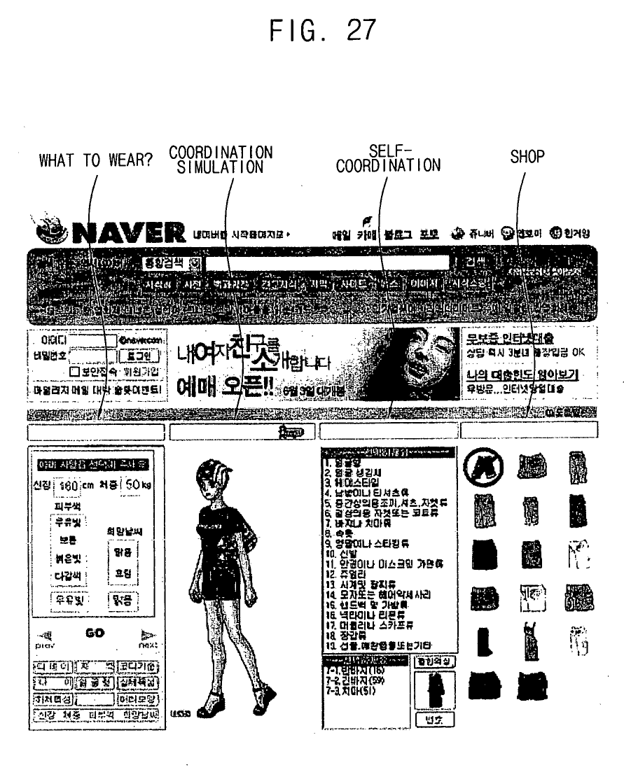

FIG. 26 is a display view illustrating an online service and FIG. 27 is a display view illustrating a service in a portal site and the like.

The website of the business 410 with the installed coordination program may present the coordination according to the user's 420 desired coordination including the individual's character fitting to the body shape information of the user, through the coordination simulation system 402.

When the user 420 requests for the item after seeing the desired coordination, the online service business server 400 handles the displayed coordination image through the normal online customer's request process and the approval process.

The business server 400 delivers the sold goods using typical delivering methods and divides profits with the seller.

When the customer requests the custom-made items, the business server 400 requests the custom-made items by dispatching the custom-made order sheet to the seller, receives the custom-made items from the seller and delivers the custom-made items to the customer.

The business server 400 evaluates the body shape condition and the fashion coordination of users 420, selects the most suitable users with a particular item as a model of the item, and then presents the user to the seller or links the user to an additional service such as scouts for models or entertainers.

Having described the example embodiments of the present invention and its advantages, it is noted that various changes, substitutions and alterations can be made herein without departing from the spirit and scope of the invention as defined by appended claims.

### INDUSTRIAL APPLICABILITY

The present invention provides a method of creating a pseudo-3D image based on a 2D image so that an image with 3D quality is provided, and processing speed and available memory are increased by 2D image processing.

The present invention provides a pseudo-3D total clothes coordination method saving costs and time, and provides diverse coordination using coordination image development based on a pseudo-3D converting module. Table 1 represents a comparison of the conventional 2D coordination systems and the 3D coordination system of the present invention.

TABLE 1

| | | Low | High | |
|---|---|---|---|---|
| | 2D Image | Quality 3D | Quality 3D | Pseudo-3D |
| Production | 50,000 to | 200,000 to | 50,000,000 to | 50,000 to |
| Costs | 100,000 | 500,000 | hundreds of | 100,000 |
| (won) | | | millions | |
| Production | 12 | 72 | 168 | 6 |
| Time | | | | |
| (hours) | | | | |
| Production | Illustrator, | 3D Studio | 3D Studio | 2.9D |
| Program | Photoshop | MAX | MAX, MAYA | Convert |
| System | Higher than | Higher than | Higher than | Higher than |
| Require- | Pentium 3 | Pentium 3 | Pentium 4 | Pentium 3 |
| ments | 400 MHz | 800 MHz | 1.0 GHz | 400 MHz |
| Capacity | 1M | Under 5M | More than 5M | Under 1M |
| Loading | High | Medium | Low | High |
| Speed | | | | |
| Rotation | Impossible | Possible | Possible | Possible |
| Detail Level | Low | Medium | High | Medium |
| Aesthetic | High | Low | High | High |
| View | | | | |

The present invention has a similar visual quality to the 3D simulation system but has similar levels with the 2D simulation system with respect to production costs, production time, system requirements, capacity, loading speed and the like.

In case of the 3D system having high quality, the production costs of the model character and the clothes coordination image are different according to a number of polygons. When the number of polygons is more than about 100,000, the production costs may be about 50 million to more than 100 million Korean won, and the production time may be more than 1 month, wherein the number of polygons is a number of the surfaces forming a 3D model. In case that the number of polygons is fewer than 100 thousand, the costs may be different according to a detail level. For example, in case the number of polygons is about 20 thousand, the costs may be about 500 thousand Korean won.

Small-scale businesses and the SOHO businesses using systems having low specifications may not support the 3D coordination systems in real time and have difficulty in using the 3D coordination systems because of high costs. However, the high-quality coordination system of the present invention may provide an online real-time service with low costs, to facilitate selling of diverse goods.

1. A pseudo-3D total clothes coordination method comprising:
preparing a 2D standard avatar image, a standard 2D image and a pseudo-3D image;
providing a user information;
generating a pseudo-3D user-adapted avatar image by correcting the 2D standard avatar image automatically based on the user information; and
performing an automatic coordination corresponding to the user information by converting the standard 2D image to a pseudo-3D coordination image automatically in response to the corrected pseudo-3D user-adapted avatar image.

2. The pseudo-3D total clothes coordination method of claim 1, wherein generating the pseudo-3D image comprises:
preparing a red-green-blue(RGB)-format 2D image;
converting the RGB-format 2D image to a hue-saturation-intensity (HSI)-format image;
obtaining a control point of a polynomial function according to an brightness distribution chart of the HSI-format image;
creating a 3D curved surface by using a B-spline from the control point;
creating a virtual 2D development figure by applying a physical technique to the 3D curved surface;
mapping pattern to the 3D curved surface by using the coordinate values of the virtual 2D development figure; and
generating the pseudo-3D image by applying a shading function to the pattern-mapped 3D curved surface.

3. The pseudo-3D total clothes coordination method of claim 2, wherein the 3D curved surface is created by applying the B-spline function to the intensity value.

4. The pseudo-3D total clothes coordination method of claim 1, wherein the user information comprises a primary size information, a personal information, a location information, a style information and other coordination-related information of a user or a combination thereof.

5. The pseudo-3D total clothes coordination method of claim 4, wherein generating the pseudo-3D user-adapted avatar image comprises:
deriving a secondary size information automatically by using the primary size information and the personal information; and
correcting a size of the 2D standard avatar image automatically based on the primary size information, the secondary size information and the personal information.

6. The pseudo-3D total clothes coordination method of claim 5, wherein the user information further comprises a facial image information of the user and the facial image information is inserted into the generated avatar image.

7. The pseudo-3D total clothes coordination method of claim 5, wherein the secondary size information is automatically derived by an artificial intelligence algorithm with reference to a statistical data of the coordination subject.

8. The pseudo-3D total clothes coordination method of claim 7, wherein correcting the size of the 2D standard avatar image automatically comprises:
dividing the 2D standard avatar image into groups and setting control points corresponding to the groups respectively;
linearly adjusting the size of the 2D standard avatar image according to a size change of each group; and
correcting a color value of each pixel according to the size adjustment.

9. The pseudo-3D total clothes coordination method of claim 8, wherein the color value of each pixel is corrected according to a coordinate change of the pixel by a luminance value interpolation.

10. The pseudo-3D total clothes coordination method of claim 8, wherein generating the pseudo-3D user-adapted avatar image comprises:
setting a control point of the pseudo-3D image corresponding to a control point of the 2D standard avatar image;
linearly adjusting a size of the control point according to the size change of the 2D standard avatar image;
correcting the color value of each pixel according to the size change; and
merging the 3D user-adapted avatar image and the corrected pseudo-3D coordination image by setting a gap between the 3D user-adapted avatar image and the corrected pseudo-3D coordination image.

11. The pseudo-3D total clothes coordination method of claim 4, wherein performing an automatic coordination comprises:
automatically generating the pseudo-3D coordination image most adaptive to the user by using the 2D image, a pattern, a color code, based on the personal information, the location information, the style information and other coordination-related information of the user or a combination thereof;
coordinating the pseudo-3D user-adapted avatar image by using the generated pseudo-3D coordination image;
acquiring a modified information by the artificial intelligence algorithm, the modified information being provided by the user as a response to the coordinated pseudo-3D user-adapted avatar image; and
reflecting the acquired modified information to the style information.

12. A method of providing pseudo-3D user-adapted total clothes coordination using artificial intelligence, the method comprising:
providing a coordination-related information of a user including a primary body shape information, a personal information and a style information;
deriving a secondary body shape information through an artificial intelligence algorithm, based on the primary body shape information and the personal information;
generating a pseudo-3D user-adapted avatar image suitable to a user's body condition by using a 2D standard avatar image, based on the primary body shape information, the secondary body shape information and the personal information;
generating the pseudo-3D image automatically through the artificial intelligence algorithm, based on the user's coordination-related information; and
displaying the pseudo-3D user-adapted avatar image to which the generated pseudo-3D image is applied.

13. The method of claim 12, wherein the secondary body shape information most suitable to the user's body shape is derived through the artificial intelligence algorithm, based on statistical data of body shape.

14. The method of claim 13, wherein the primary body information and the personal information include sex, age, height, weight and bust girth.

15. The method of claim 14, wherein the secondary body shape information comprises a user's shoulder width, body width, bust width, bust thickness, shoulder height and waist height.

16. The method of claim 12, further comprising:
entering modified coordination information of the user-adapted avatar image;
acquiring of a user's style through the modified coordination information by the artificial intelligence algorithm; and
reflecting the acquired user's modified style to the user's style information.

17. The method of claim 16, wherein generating the pseudo-3D coordination image performs an automatic generation in response to a coordination presentation according to a user's style, a user's location, weather, a purpose and the like.

18. An online service method of using a pseudo-3D total clothes coordination comprising:
enrolling as a seller member on a service website;
registering a selling item;
creating a standard 2D image of the registered item;
installing ActiveX by inserting an HTML code of the pseudo-3D user-adapted coordination program using artificial intelligence on the service website;
displaying a coordination of the selling item according to a coordination request of a user on the coordination program;
processing a purchase request of the user for the displayed coordination image; and
dividing profits from the item.

19. The online service method of claim 18, wherein creating the standard 2D image comprises:
drawing in an item such as a clothes having a specific style on a presented basic 2D coordination image;
assembling additional patterns by selecting prepared accessories such as a collar, a pocket, a button, a logo, a decoration and so on;
uploading a new additional pattern or an item pattern; and
adjusting sizes of the respective accessories when assembling additional patterns.

20. The online service method of claim 18 further comprising:
requesting a custom-made order fitting to a user body shape information through the pseudo-3D user-adapted total clothes coordination method using artificial intelligence; and
manufacturing and selling the custom-made clothes fitting to the user body shape information derived from the program in response to the custom-made order.

21. The online service method of claim 18 further comprising:
evaluating the user body shape information and the user coordination style through the pseudo-3D user-adapted total clothes coordination method using artificial intelligence; and
recommending the user as a fashion model candidate when the user receives a grade over a specific level according to the evaluated result.

22. The online service method of claim 19, further comprising:
creating a user-desired item by using the standard image assembling tool; and
processing the order and delivering the created design through the pseudo-3D user-adapted total clothes coordination program using artificial intelligence.

23. A method of generating a pseudo-3D avatar, the method comprising:
preparing a 2D standard avatar image, a standard 2D image and a pseudo-3D image;
providing user information;
generating a pseudo-3D user-adapted avatar image by automatically correcting the 2D standard avatar image based on the user information; and
coordinating the pseudo-3D avatar image automatically by automatically converting the standard 2D image to the pseudo-3D coordination image in response to the correction of the 3D user-adapted avatar image.

24. The method of claim 23, wherein the user information comprises a user's facial image, and
the user's facial image is inserted into the generated avatar image.
